(19) United States
(12) Patent Application Publication
(10) Pub. No.: US 2012/0042214 A1
(43) Pub. Date: Feb. 16, 2012

(54) METHOD FOR DETECTING THE IMPENDING ANALYTICAL FAILURE OF NETWORKED DIAGNOSTIC CLINICAL ANALYZERS

(76) Inventors: Merrit N. Jacobs, Lake Worth, FL (US); Christopher Thomas Doody, Shortsville, NY (US); Edwin Craig Bashaw, Webster, NY (US); Joseph Michael Indovina, Hilton, NY (US); Owen Altland, Webster, NY (US); Nicholas John Gould, Cedex (FR)

(21) Appl. No.: 13/203,416

(22) PCT Filed: Feb. 24, 2010
(86) PCT No.: PCT/US10/25191

§ 371 Date: Sep. 12, 2011

Related U.S. Application Data
(60) Provisional application No. 61/155,993, filed on Feb. 27, 2009.

(51) Int. Cl. G06F 11/30

(52) U.S. Cl. 714/47.2; 714/E11.179

(57) ABSTRACT

A method of detecting impending analytical failure in a networked diagnostic clinical analyzer is based upon detecting whether the operation of a particular analyzer is statistically distinguishable based on one or more thresholds. A failure occurs when one or more components or modules of the analyzer fails. A method to detect such an impending failure is disclosed. Baseline data on a pre-selected set of analyzer variables for a population of diagnostic clinical analyzers is used to generate an impending failure threshold. Subsequently, operational data comprising the same pre-selected set of analyzer variables allows generation of a time series of operational statistics. If the operational statistic exceeds the impeding failure threshold in a prescribed manner, an impending analytical failure is predicted. Such detection of impending analytical failures facilitates intelligent scheduling of service for the analyzer in question to maintain high assay throughput and accuracy.

The invention relates generally to the detection of impending analytical failures in networked diagnostic clinical analyzers.

### BACKGROUND OF THE INVENTION

Automated analyzers are a standard fixture in the clinical laboratory. Assays that used to require significant manual human involvement are now handled largely by loading samples into an analyzer, programming the analyzer to conduct the desired tests, and waiting for results. The range of analyzers and methodologies in use is large. Some examples include spectrophotometric absorbance assay such as end-point reaction analysis and rate of reaction analysis, turbidimetric assays, nephelometric assays, radiative energy attenuation assays (such as those described in U.S. Pat. Nos. 4,496,293 and 4,743,561 and incorporated herein by reference), ion capture assays, colorimetric assays, fluorometric assays, electrochemical detection systems, potentiometric detection systems, and immunoassays. Some or all of these techniques can be done with classic wet chemistries; ion-specific electrode analysis (ISE); thin-film formatted dry chemistries; bead and tube formats or microtitre plates; and the use of magnetic particles. U.S. Pat. No. 5,885,530 provides a description useful for understanding the operation of a typical automated analyzer for conducting immunoassays in a bead and tube format and is incorporated herein by reference.

Needless to say, diagnostic clinical analyzers are becoming increasingly complex electro-mechanical devices. In addition to stand alone dry chemistry systems and stand alone wet chemistry systems, integrated devices comprising both type of analysis are in commercial use. In these so-called combinational clinical analyzers, a plurality of dry chemistry systems and wet chemistry systems, for example, can be provided within a contained housing. Alternatively, a plurality of wet chemistry systems can be provided within a contained housing or a plurality of dry chemistry systems can be provided within a contained housing. Furthermore, like systems, e.g., wet chemistry systems or dry chemistry systems, can be integrated such that one system can use the resources of another system should it prove to be an operational advantage.

Each of the above chemistry systems is unique in terms of its operation. For example, known dry chemistry systems typically include a sample supply, a reagent supply that includes a number of dry slide elements, a metering/transport mechanism, and an incubator having a plurality of test read stations. A quantity of sample is aspirated into a metering tip using a proboscis or probe carried by a movable metering truck along a transport rail. A quantity of sample from the tip then is metered (dispensed) onto a dry slide element that is loaded into the incubator. The slide element is incubated, and a measurement such as optical or another read is taken for detecting the presence or concentration of an analyte. Note that for dry chemistry systems the addition of a reagent to the input patient sample is not required.

A wet chemistry system, on the other hand, utilizes a reaction vessel such as a cuvette, into which quantities of patient sample, at least one reagent fluid, and/or other fluids are combined for conducting an assay. The assay also is incubated and tests are conducted for analyte detection. The wet chemistry system also includes a metering mechanism to transport patient sample fluid from the sample supply to the reaction vessel.

Despite the array of different analyzer types and assay methodologies, most analyzers share several common characteristics and design features. Obviously, some measurement is taken on a sample. This requires that the sample be placed in a form appropriate to the measurement technique. Thus, a sample manipulation system or mechanism is found in most analyzers. In wet chemistry devices, sample is generally placed in a sample vessel such as a cup or tube in the analyzer so that aliquots can be dispersed to reaction cuvettes or some other reaction vessel. A probe or proboscis using appropriate fluid handling devices such as pumps, valves, liquid transfer lines such as pipes and tubing, and driven by pressure or vacuum are often used to meter and transfer a predetermined quantity of sample from the sample vessel to the reaction vessel. The sample probe or proboscis or a different probe or proboscis is also often required to deliver diluent to the reaction vessel particularly where a relatively large amount of analyte is expected or found in the sample. A wash solution and process are generally needed to clean a non-disposable metering probe. Here too, fluid handling devices are necessary to accurately meter and deliver wash solutions and diluents.

In addition to sample preparation and delivery, the action taken on the sample that manifests a measurement often requires dispensing a reagent, substrate, or other substance that combines with the sample to create some noticeable event such as florescence or absorbance of light. Several different substances are frequently combined with the sample to attain the detectable event. This is particularly the case with immunoassays since they often require multiple reagents and wash steps. Reagent manipulation systems or mechanisms accomplish this. Generally, these metering systems require a wash process to avoid carryover. Once, again, fluid handling devices are a central feature of these operations.

Other common systems elements include measurement modules that include some source of stimulation together with some mechanism for detecting the stimulation. These schemes include, for example, monochromatic light sources and calorimeters, reflectometers, polarimeters, and luminometers. Most modern automated analyzers also have sophisticated data processing systems to monitor analyzer operations and report out the data generated either locally or to remote monitoring centers connected via a network or the Internet. Numerous subsystems such as reagent cooler systems, incubators, and sample and reagent conveyor systems are also frequently found within each of the major systems categories already described.

An analytical failure, as the term is used in this specification, occurs when one or more components or modules of a diagnostic clinical analyzer begins to fail. Such failures can be the result of initial manufacturing defects or longer-term wear and deterioration. For example, there are many different kinds of mechanical failure, and they include overload, impact, fatigue, creep, rupture, stress relaxation, stress corrosion cracking, corrosion fatigue and so on. These single component failures can result in an assay result that is believable yet unacceptably inaccurate. These inaccuracies or precision losses can be further enhanced by a large number of factors such as mechanical noise or even inefficient software programming protocols. Most of these are relatively easy to address. However, with analyte concentrations often measured in the μg/dL, or even ng/dL, range, special attention must be paid to sample and reagent manipulation systems and those supporting systems and subsystems that affect the sample and reagent manipulation systems. The sample and reagent manipulation systems require the accurate and precise transport of small volumes of liquids and thus generally incorporate extraordinarily thin tubing and vessels such as those found in sample and reagent probes. Most instruments require the simultaneous and integrated operation of several unique fluid delivery systems, each one of which is dependent on numerous parts of the hardware/software system working correctly. Some parts of these hardware/software systems have failure modes that may occur at a low level of probability. A defect or clog in such a probe can result in wildly erratic and inaccurate results and thus be responsible for analytical failures. Likewise, a defective washing protocol can lead to carryover errors that give false readings for a large number of assay results involving a large number of samples. This can be caused by adherence of dispensed fluid to the delivery vessel (e.g., probe or proboscis). Alternatively, where the vessel contacts reagent or diluent it can lead to over diluted and thus under reported results. Entrainment of air or other fluids to a dispensed fluid can cause the volume of the dispensed fluid to be below specification since a portion of the volume attributed to the dispensed fluid is actually the entrained fluid. When problems as described above can be clearly identified by the clinical analyzer, the standard operating procedure is to issue an error code whose numerical value defines the type of error detected and to withhold the numerical result of the assay requesting that either the identified problem be resolved or, at a minimum, the requested assay be rerun. Analytical failures resulting from the above described problems have been addressed in U.S. Publication. No. 2005/0196867 and which is herein incorporated by reference. In addition, there are established methods that have been developed to monitor diagnostic clinical analyzers, which specifically address the above described problems, that are a form of statistical process control as detailed by James O. Westgard, Basic QC Practices: Training in Statistical Quality Control for Healthcare Laboratories, 2^{nd} edition, AACC Press, 2002, which is hereby incorporated by reference and by Carl A. Burtis, Edward R. Ashwood, and David E. Bruns, Tietz Fundamentals of Clinical Chemistry, 6^{th} edition, Saunders, 2007, which is hereby incorporated by reference.

However, in addition to the individual component-related or module-related problems described above, there is also a class of system-related problems that can cause analytical failure. System-related problems develop from the gradual deterioration of multiple components and subsystems over time and manifest themselves as an increase in the variability of assay measurements. One feature of this class of system-related problems is that unlike the situation described above and defined in US 2005/0196867, a definitive error cannot be detected, and as a result, an error code is not issued and the numerical assay result is not withheld. Of particular concern in micro-tip and micro-well methodologies are thermal stability issues, both ambient and incubator. Because multiple components and subsystems are involved, it is not possible to monitor a single variable to detect the impending analytical failure, but it is necessary to monitor multiple variables. Measurements of these variables can be used to detect impending analytical failures as described herein and can also be used to monitor the overall operation of the analyzer as detailed in James O. Westgard and in Carl A. Burtis et al. previously incorporated by reference above. Of course, a key issue is which set of variables should be monitored. For most diagnostic clinical analyzers in commercial use, this is most easily answered by analysis of the analyzer error budget normally developed during the design phase of analyzer development. Error budget calculations are a specialized form of sensitivity analysis. They determine the separate effects of individual error sources, or groups of error sources, which are thought to have potential influence on system accuracy. In essence, the error budget is a catalog of those error sources. Error budgets are a standard fixture in complex electronic systems designs. For an early example, see Arthur Gelb, Editor, Applied Optimal Estimation, The MIT Press, 1974, p. 260, which is herein incorporated by reference. As not all variables associated with the operation of a diagnostic clinical analyzer can be easily measured, a systematic approach to identifying which variables should be monitored is required. One such approach is the tornado table or diagram. The

Appendix contains an example of the use of tornado analysis in a very simplified electronic circuit. Ultimately the decision to monitor a set of variables is an engineering decision.

U.S. Pat. No. 5,844,808; U.S. Pat. No. 6,519,552; U.S. Pat. No. 6,892,317; U.S. Pat. No. 6,915,173; U.S. Pat. No. 7,050,936; U.S. Pat. No. 7,124,332; and U.S. Pat. No. 7,237,023 teach or suggest various methods and devices for detecting the failures, but fall short of predicting failures while allowing satisfactory use of equipment. Indeed, failure at some point in time in the future is expected for any equipment. Ordering expected failures in a systematic manner is not taught or suggested by the specific methods or devices disclosed in these documents.

### SUMMARY OF THE INVENTION

Accordingly, this application provides a method for predicting the impending analytical failure of a networked diagnostic clinical analyzer in advance of the diagnostic clinical analyzer producing assay results with unacceptable accuracy and precision. This disclosure is not directed to detecting if a failure has already taken place because such determinations are made by other functionalities and circuits in diagnostic analyzers. Further, not all failures affect the reliability of the results generated by a clinical diagnostic analyzer. Instead, this disclosure is concerned with detecting impending failures, and assisting in remedying the same to improve the overall performance of clinical diagnostic analyzers.

Another aspect of this application is directed to a methodology for dispatching service representatives to a networked diagnostic clinical analyzer in advance of the analytical failure of the diagnostic clinical analyzer.

A preferred method for predicting an impending failure in a diagnostic clinical analyzer includes the steps of monitoring a plurality of variables in a plurality of diagnostic clinical analyzers, screening out outliers from values of monitored variables, deriving a threshold—such as the baseline control chart limit—for each of the monitored variables based on the values of monitored variables screened to remove outliers, normalizing the values of the monitored variables, generating a composite threshold using normalized values of monitored variables, collecting operational data about the monitored variables from a particular diagnostic clinical analyzer and generating an alert if the composite threshold is exceeded by the particular diagnostic clinical analyzer.

An outlier value of a variable is a value that is expected to occur, based on the underlying expected or presumed distribution, at a rate selected from the set consisting of no more than 3%, no more than 1%, no more than 0.1% and no more than 0.01%.

In a preferred embodiment, the threshold for a particular monitored variable is also used to normalize the monitored variable. This implementation choice is not intended to and should not be understood to be a limitation on the scope of the invention unless such is expressly indicated in the claims. Alternative embodiments may normalize monitored variables differently. Normalization ensures that a composite threshold, such as a Baseline Composite Control Chart Limit, reflects appropriately weighted underlying variable values. Normalization enables using parameters as a component of the composite threshold even when the parameter values are numerically different by orders of magnitude. As an example the ambient temperature SD, percent metering condition codes and negative first derivative of lamp current combined following normalization even though prior to normalization their values nominally are orders of magnitude apart.

In a preferred embodiment, an alert for an impending failure is generated for a particular diagnostic clinical analyzer if the variables monitored for that particular diagnostic clinical analyzer exceed the composite threshold in a prescribed manner, such as once, on two times out of three successive time points, or a present number of times in a specified time interval or period of operation. Further, unless expressly indicated otherwise, an impending failure refers to an increased frequency of variations in performance, even when the assay results are well within the bounds of variation specified by the assay or the relevant reagent manufacturer. Such implementation choices are not intended to and should not be understood to limit the scope of the invention unless such is expressly indicated in the claims.

Further objects, features, and advantages of the present application will be apparent to those skilled in the art from detailed consideration of the preferred embodiments that follow.

### BRIEF DESCRIPTION OF THE DRAWINGS

FIG. 1 is a diagram of the integrated diagnostic clinical analyzer and general-purpose computer network. A plurality of independently operating diagnostic clinical analyzers 101, 102, 103, 104, and 105 are connected to a network 106. At some initial point in time 107, referred to as the baseline time, all diagnostic clinical analyzers 101, 102, 103, 104, and 105 collect, and subsequently, transfer data to the general-purpose computer 112. At future points in time 108, 109, 110, and 111 additional operational data are collected and transferred to the general-purpose computer 112.

FIG. 2 is a diagram of an Assay Predictive Alerts Control Chart showing the robust, statistical control chart limit 201 as derived from baseline data and the value of the statistic computed from operational data reported to the general-purpose computer 112 from a particular diagnostic clinical analyzer for a series of twenty-five daily time periods as indicated by the data points 202. Note that two out of three of the statistic values exceed the control chart limit for days 23, 24, and 25.

FIG. 3 is a diagram of the data setup for the computation of the control chart limit using baseline data for Example 1. Column 301 denotes a specific diagnostic clinical analyzer in the population of 862 analyzers. Column 302 denotes the reported percent error codes by analyzer, hereafter known as the baseline error1 value. Column 303 denotes the normalized percent error codes value by analyzer, hereafter known as the normalized baseline error1 value. Column 304 denotes the reported analog to digital voltage counts by analyzer, hereafter known as the baseline range1 value. Column 305 denotes the normalized analog to digital voltage counts by analyzer, hereafter known as the normalized baseline range1 value. Column 306 denotes the reported ratio of the average value of three validation numbers to the expected value of three signal voltages by analyzer, hereafter known as the baseline ratio1 value. Column 307 denotes the normalized ratio of the average value of three validations numbers to the average value of three signal voltages by analyzer, hereafter known as the normalized baseline ratio1 value. Column 308 is the average value of the three normalized values in columns 303, 305, and 307, hereafter known as the baseline composite1 value. Row 309 is the mean of the values in column 302, column 304, column 306, and column 308, respectively. Row 310 is the standard deviation of the values in column 302, column 304, column 306, and column 308, respectively. Row 311 is the mean of the values remaining in column 302, column 304, column 306, and column 308, respectively, after values not included in the range of the mean plus or minus three standard deviations have been removed. The row 311 means are denoted the trimmed means. Row 312 is the standard deviation of the values remaining in column 302, column 304, column 306, and column 308, respectively, after values not included in the range of the mean plus or minus three standard deviations have been removed. The row 312 standard deviations are denoted the trimmed standard deviations. Row 313 is the individual control chart limit values composed of the trimmed means, in row 311, plus three times the trimmed standard deviations, in row 312, for column 302, column 304, column 306, and column 308, respectively. The element in row 313 and column 308 is the baseline composite1 control chart limit.

FIG. 4 is a diagram of the histogram obtained from the analysis of the reported percent error codes obtained from surveying the population of 862 diagnostic clinical analyzers in Example 1 over a specific point in time.

FIG. 5 is a diagram of the histogram obtained from the analysis of the reported analog to digital counts obtained from surveying the population of 862 diagnostic clinical analyzers in Example 1 over a specific point in time.

FIG. 6 is a diagram of the histogram obtained from the analysis of the reported ratio of average validation numbers to average signal voltages obtained from surveying the population of 862 diagnostic clinical analyzers in Example 1 over a specific point in time.

FIG. 7 is a diagram of the data setup for the computation of the composite1 value using operational data for Example 1. Column 701 denotes the date that the data was taken. Column 702 denotes the reported percent error codes by analyzer, hereafter known as the operational error1 value, for each date respectively. Column 703 denotes the normalized percent error codes value by analyzer, hereafter known as the normalized operational error1 value, for each date respectively. Column 704 denotes the reported analog to digital voltage counts by analyzer, hereafter known as the operational range1 value, for each date respectively. Column 705 denotes the normalized analog to digital voltage counts by analyzer, hereafter known as the normalized operational range1 value, for each date respectively. Column 706 denotes the reported ratio of the average value of three validations numbers to the average value of three signal voltages by analyzer, hereafter known as the operational ratio1 value, for each date respectively. Column 707 denotes the normalized ratio of the average value of three validations numbers to the average value of three signal voltages by analyzer, hereafter known as the normalized operational ratio1 value, for each date respectively. Column 708 is the average value of the three normalized values in columns 703, 705, and 707, hereafter known as the operational composite1 value, for each date respectively.

FIG. 8 is a diagram of the control chart where the daily value of operational composite1 is plotted for Example 1. A line 801 representing the trimmed baseline composite1 control chart limit of about 74.332 is shown in the graph. The daily values of the operational composite1 are represented by dots 802.

FIG. 9 is a diagram of a simple electronic circuit that has four signal inputs: W 901, X 902, Y 903, and Z 904. These four signals have the characteristics of independent random variables. Signals W 901 and X 902 are combined in an adder 905 resulting in signal A 906. Signal A 906 is combined with signal Y 903 in a multiplier 907 resulting in signal B 908. Signal B 908 is combined with signal Z 904 in an adder 910 resulting in signal C 909.

FIG. 10 is a tornado diagram showing the influence of various input variables on the output variance of signal C in the model circuit discussed in the Appendix along with a table of the values in the diagram.

FIG. 11 is a diagram of the data setup for the computation of the control chart limit using baseline data for Example 2. Column 1101 denotes a specific diagnostic clinical analyzer in the population of 758 analyzers. Column 1102 denotes the standard deviation of the error in the incubator temperature by analyzer, hereafter known as the baseline incubator2 value. Column 1103 denotes the normalized standard deviation of the incubator temperature by analyzer, hereafter known as the normalized baseline incubator2 value. Column 1104 denotes the standard deviation of the error in the MicroTip™ reagent supply temperature by analyzer, hereafter known as the baseline reagent2 value. Column 1105 denotes the normalized standard deviation of the error in the MicroTip™ reagent supply temperature by analyzer, hereafter known as the normalized baseline reagent2 value. Column 1106 denotes the standard deviation of the ambient temperature by analyzer, hereafter known as the baseline ambient2 value. Column 1107 denotes the normalized standard deviation of the ambient temperature by analyzer, hereafter known as the normalized baseline ambient2 value. Column 1108 denotes the percent condition codes of the combined secondary metering and three read delta check codes by analyzer, hereafter known as the baseline codes2 value. Column 1109 denotes the normalized percent condition codes of the combined secondary metering and three read delta check codes by analyzer, hereafter known as the normalized baseline codes2 value. Column 1110 is the average value of the four normalized values in columns 1103, 1105, 1107, and 1109, hereafter known as the baseline composite2 value. Row 1111 is the mean of the values in column 1102, column 1104, column 1106, column 1108, and column 1110, respectively. Row 1112 is the standard deviation of the values in column 1102, column 1104, column 1106, column 1108, and column 1110, respectively. Row 1113 is the mean of the values remaining in column 1102, column 1104, column 1106, column 1108, and column 1110, respectively, after values not in the range of the mean plus or minus three standard deviations have been removed. The row 1113 means are denoted the trimmed means. Row 1114 is the standard deviation of the values remaining in column 1102, column 1104, column 1106, column 1108, and column 1110, respectively, after values not in the range of the mean plus or minus three standard deviations have been removed. The row 1114 standard deviations are denoted the trimmed standard deviations. Row 1115 is the individual control limit values composed of the trimmed mean, in row 1113, plus three trimmed standard deviations, in row 1114, for column 1102, column 1104, column 1106, column 1108, and column 1110, respectively.

FIG. 12 is a diagram of the data setup for the computation of the composite2 value using operational data for Example 2. Column 1201 denotes the date that the data was taken. Column 1202 denotes the standard deviation of the incubator temperature by analyzer, hereafter known as the operational incubator2 value, for each date respectively. Column 1203 denotes the normalized standard deviation of the incubator temperature by analyzer, hereafter known as the normalized operational incubator2 value, for each date respectively. Column 1204 denotes the standard deviation of the MicroTip™ reagent supply temperature by analyzer, hereafter known as the operational reagent2 value, for each date respectively. Column 1205 denotes the normalized standard deviation of the MicroTip™ reagent supply temperature by analyzer, hereafter known as the normalized operational reagent2 value, for each date respectively. Column 1206 denotes the standard deviation of the ambient temperature by analyzer, hereafter known as the operational ambient2 value, for each date respectively. Column 1207 denotes the normalized standard deviation of the ambient temperature by analyzer, hereafter known as the normalized operational ambient2 value, for each date respectively. Column 1208 denotes the percent condition codes of the combined secondary metering and three read delta check codes by analyzer, hereafter known as the operational codes2 value, for each date respectively. Column 1209 denotes the normalized percent condition codes of the combined secondary metering and three read delta check codes by analyzer, hereafter known as the normalized operational codes2 value, for each date respectively. Column 1210 is the average value of the four normalized values in columns 1203, 1205, 1207, and 1209, hereafter known as the operational composite2 value, for each date respectively.

FIG. 13 is a diagram of the control chart where the daily value of operational composite2 is plotted for Example 2. The baseline composite2 control chart limit 1301 is shown to be approximately 89.603 in this graph. The daily values of the operational composite2 are represented by dots 1302.

FIG. 14 is a diagram of the data setup for the computation of the composite3 value using operational data for Example 3. Column 1401 denotes the date that the data was taken. Column 1402 denotes the standard deviation of the incubator temperature by analyzer, hereafter known as the operational incubator3 value, for each date respectively. Column 1403 denotes the normalized standard deviation of the incubator temperature by analyzer, hereafter known as the normalized operational incubator3 value, for each date respectively. Column 1404 denotes the standard deviation of the MicroTip™ reagent supply temperature by analyzer hereafter known as the operational reagent3 value, for each date respectively. Column 1405 denotes the normalized standard deviation of the MicroTip™ reagent supply temperature by analyzer, hereafter known as the normalized operational reagent3 value, for each date respectively. Column 1406 denotes the standard deviation of the ambient temperature by analyzer, hereafter known as the operational ambient3 value, for each date respectively. Column 1407 denotes the normalized standard deviation of the ambient temperature by analyzer, hereafter known as the normalized operational ambient3 value, for each date respectively. Column 1408 denotes the percent condition codes of the combined secondary metering and three read delta check codes by analyzer, hereafter known as the operational codes3 value, for each date respectively. Column 1409 denotes the normalized percent condition codes of the combined secondary metering and three read delta check codes by analyzer, hereafter known as the normalized operational codes3 value, for each date respectively. Column 1410 is the average value of the four normalized values in columns 1403, 1405, 1407, and 1409, hereafter known as the operational composite3 value, for each date respectively.

FIG. 15 is a diagram of the control chart where the daily value of operational composite3 value is plotted for Example 3. The baseline composite3 control chart limit 1501 is shown to be approximately 89.603 in this graph. The daily values of the operational composite3 are represented by dots 1502.

FIG. 16 is a flowchart of the software used to compute the baseline composite control chart limit and operational data points. Processing begins at the START ellipse 1601 after which the number of analyzers 1602 for which data is available is input. After baseline data for one analyzer is read 1603, a check is made 1604, to see if data for additional analyzers remains to be input. If yes, control is returned to the 1603 block, otherwise the baseline mean and standard deviation is computed for each input variable 1605 over the cross-section of all analyzers. Now, all data with values not in the range of the mean plus or minus at least three standard deviations is removed from the computational data set 1606, a process known as trimming, and the trimmed mean and standard deviation is computed for each variable 1607. Next, the baseline control chart limit value for each variable is computed 1607A, and the baseline composite control chart limit is computed 1608 using the trimmed means and standard deviations. At some point in time, perhaps significantly removed from the collection of the baseline data, the input of operational data for a specific period 1609 for a particular analyzer begins. At block 1610, a check is made to determine if additional periods of data are available. If, yes, control is returned to block 1609, otherwise, each variable's input values are divided by the variable's baseline control chart value normalizing each variable 1611. Next, the operational composite value is computed 1612. Subsequently, these operational values are stored in computer memory 1613 and compared to the baseline composite control limit previously computed 1614. If the control limit is exceeded for a specified number of times over a defined time horizon, the Remote Monitoring Center is notified of an impending analyzer analytical failure 1615, otherwise, control is returned to block 1610 to await the input of another period of operational data from the particular analyzer.

FIG. 17 is a schematic of an exemplary display of information about monitored variables on different time points and of their respective thresholds. The shaded boxes draw attention to the monitored variables exceeding their respective thresholds to aid in troubleshooting or improving the performance of an analyzer. The display aids in troubleshooting an impending failure by directing attention to suspect subsystems.

### DETAILED DESCRIPTION OF PREFERRED EMBODIMENTS

The techniques discussed within enables the management of a Remote Diagnostic Center to assess the possibility that a remote diagnostic clinical analyzer has one or more components that are about to fail (impending analytical failure) resulting in the potential of reporting assay results of unacceptable accuracy and precision.

The benefits of the techniques discussed within are detecting the impending analytical failure in advance of the actual event and servicing (determining and ameliorating the cause of the impending analytical failure) the remotely located diagnostic clinical analyzer at a time that is convenient for both the commercial entity employing the analyzer and the service provider.

For a general understanding of the present invention, reference is made to the drawings. In the drawings, like reference numerals have been used to designate identical elements. In describing the present invention, the following term(s) have been used in the description.

The term “or” used in a mathematical context refers herein to mean the “inclusive or” of mathematics such that the statement that A or B is true refers to (1) A being true, (2) B being true, or (3) both being true.

The term “parameter” refers herein to a characteristic of a process or population. For example, for a defined process or population probability density function, the mean, a parameter of the population, has a fixed, but perhaps, unknown value μ.

The term “variable” refers herein to a characteristic of a process or population that varies as an input or an output of the process or population. For example, the observed error of the incubator temperature from its desired setpoint is +0.5° C. at present represents an output.

The term “statistic” refers herein to a function of one or more random variables. A “statistic” based upon a sample from a population can be used to estimate the unknown value of a population parameter.

The term “trimmed mean” refers herein to a statistic that is an estimation of location where the data used to compute the statistic has been analyzed and restructured such that data values with unusually small or large magnitudes have been eliminated.

The term “robust statistic” refers herein to a statistic, of which the trimmed mean is a simple example, which seeks to outperform classical statistical methods in the presence of outliers, or, more generally, when underlying parametric assumptions are not quite correct.

The term “cross-sectional” refers herein to data or statistics generated in a specific time period across a number of different diagnostic clinical analyzers.

The term “time series” refers herein to data or statistics generated in a number of time periods for a specific diagnostic clinical analyzer.

The term “time period” refers herein to a length of time over which data is accumulated and individual statistics generated. For example, data accumulated over twenty-four hours and used to generate a statistic would result in a statistical value based upon a “time period” of a day. Furthermore, data accumulated over sixty minutes and used to generate a statistic would result in a statistical value based upon a “time period” of an hour.

The term “time horizon” refers herein to a length of time over which some issue is considered. A “time horizon” may contain a number of “time periods.”

The term “baseline period” refers herein to the length of time over which data from the population of diagnostic clinical analyzers on the network is collected, e.g., data might be collected daily for 24 hours.

The term “operational period” refers herein to the length of time over which data from a particular diagnostic clinical analyzer is collected, e.g., data might be collected once an hour over an operational period of 24 hours resulting in 24 observations or data points.

Variables associated with a particular design of a diagnostic clinical analyzer are selected for monitoring based upon their individual ability to identify abnormally elevated contributions to the overall error budget of the analyzer. Of course, the diagnostic clinical analyzer must be capable of measuring these variables. The decision as to how many of these variables to monitor is an engineering decision and depends upon the assay method being employed, i.e., MicroSlide™, MicroTip™, or MicroWell™ in Ortho-Clinical Diagnostics® analyzers, and the diagnostic clinical analyzer instrument itself, i.e., Vitros® 5,1 FS; Vitros® ECiQ; Vitros® 350; Vitros® DT60 II; Vitros® 3600; or Vitros® 5600. For other manufacturers, the same techniques discussed in this application work with technologically similar assays. The Appendix describes methodology using tornado tables and diagrams that may be employed to identify those variables having a large influence on accuracy or precision. Within a particular assay method for a particular analyzer, it is also possible to have multiple measuring modalities that may require a different set of variables to be monitored.

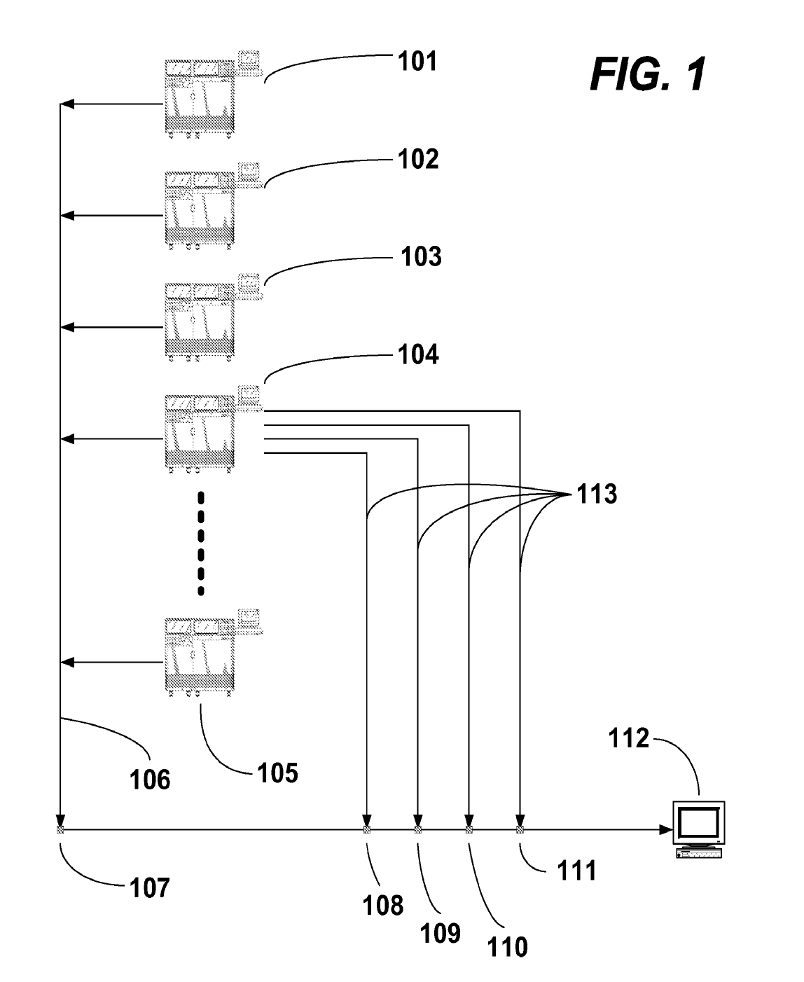

Referring now to FIG. 1, in the preferred embodiment for the analysis of diagnostic clinical analyzers using dry chemistry thin-film slides, the baseline data is collected from a plurality of diagnostic clinical analyzers 101, 102, 103, 104, and 105 in normal commercial operation over a specified first time period, normally during the Monday to Friday workweek. Baseline data accumulation over the specified first time period results in one data set per diagnostic clinical analyzer that is sent over the network 106 and is cumulatively represented by the data flow 107. The general-purpose computer 112 receives this baseline data from the plurality of diagnostic clinical analyzers on the network 106. The baseline data from a plurality of diagnostic clinical analyzers are then merged by the general-purpose computer 112 producing multiple cross-sectional observations, over a specified first time period, composed of three variables as follows: (1) the percentage of micro-slide assays resulting in a non-zero condition or error code, referred to as baseline error, (2) a measure of the variation in the primary voltage circuit, referred to as baseline range, and (3) the ratio of the average value of three validation numbers to the average value of three signal voltages, referred to as baseline ratio. To further transform this information, the mean and standard deviation of each of the three variables is computed and individual observations not included in the range of the mean plus or minus at least three standard deviations are eliminated from the collective data. This operation is known as trimming. The trimmed mean is an example of a robust statistic in that it is resistant to data outliers and contains all the information available in the trimmed data set. It should be noted that alternative preferred embodiments may use statistics that are not robust, but are based upon incomplete or fragmentary information. Subsequently, for each of the three variables, a new trimmed mean and trimmed standard deviation is calculated based upon the observations remaining in the data set.

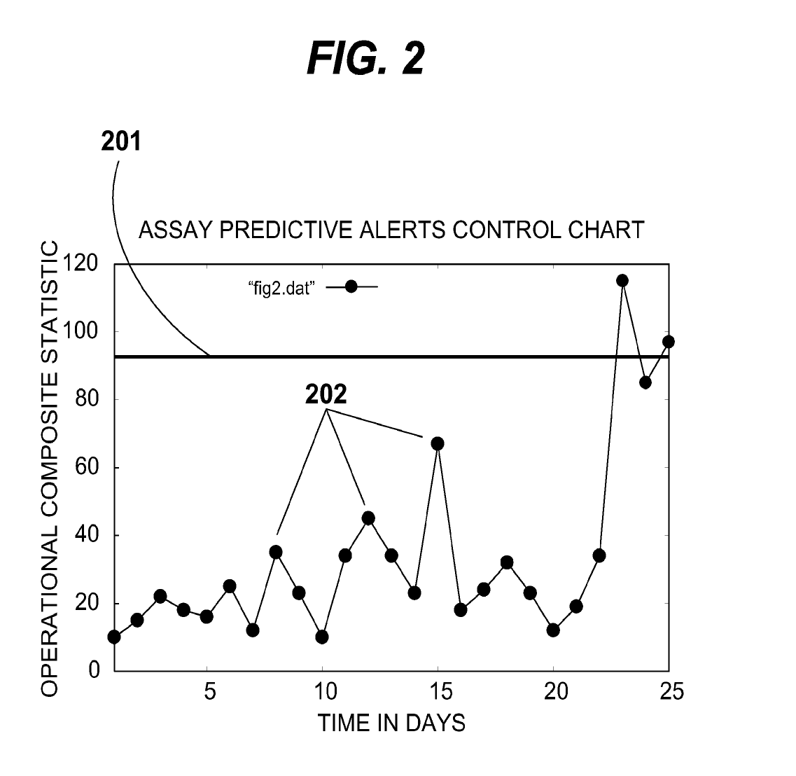

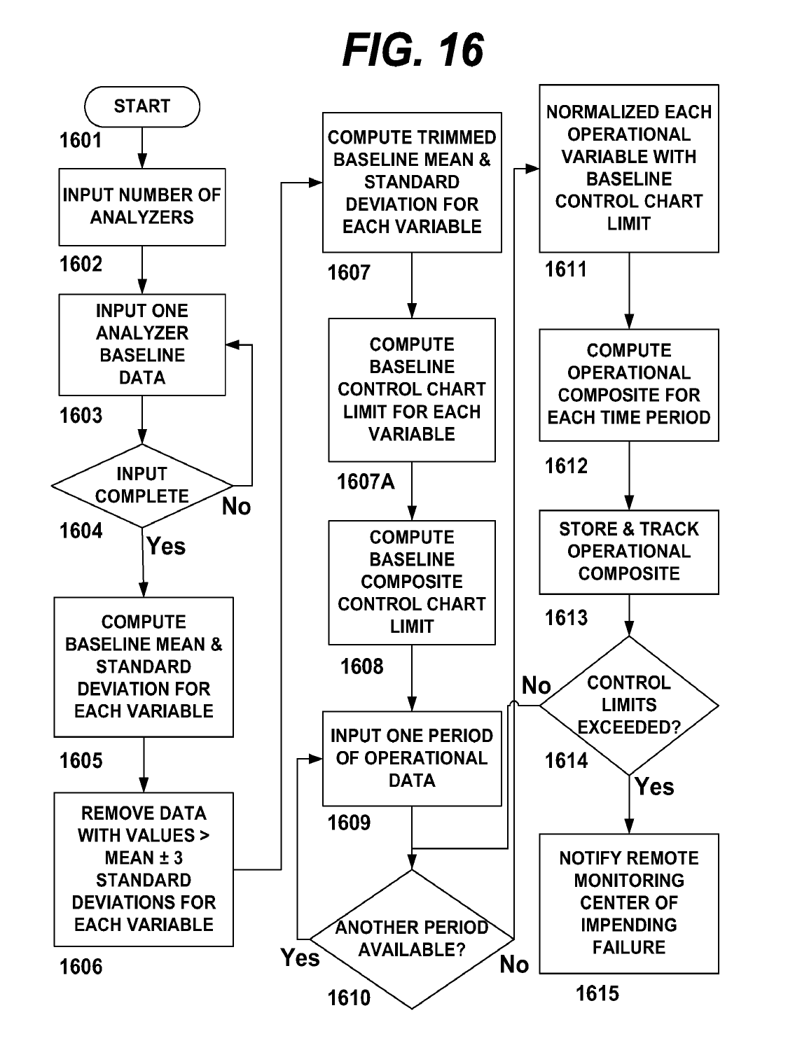

Then, the trimmed mean and trimmed standard deviation are used to compute a baseline control chart limit consisting of the trimmed mean plus at least three times the trimmed standard deviation for each of the three variables. Multiplying each variable by 100 and by dividing each variable by its baseline control chart limit, respectively, normalizes the individual baseline error, baseline range, and baseline ratio values. To reduce the normalized baseline error, normalized baseline range, and normalized baseline ratio to a single measure, an average of the three normalized values is computed, referred to as the baseline composite value. Using the same calculation steps employed to generate the baseline control chart limits above for the individual values, the mean and standard deviation of the baseline composite values are computed. Then baseline composite values not included in the range of the baseline composite mean plus or minus at least three times the baseline composite standard deviation are removed, and a trimmed baseline composite mean and trimmed baseline composite standard deviation are computed. A trimmed baseline composite control chart limit 201, as shown in FIG. 2, is then computed as the trimmed baseline composite mean plus at least three times the trimmed baseline composite standard deviation. The trimmed baseline composite control chart limit 201, the first statistic computed, is a robust statistic completely derived from the remote diagnostic clinical analyzer baseline data. It should be noted that alternative preferred embodiments may use statistics that are not robust, but are based upon incomplete or fragmentary information. A detailed flowchart of baseline computations above and operational computations below are presented in FIG. 16.

It should be noted that baseline statistics may also be used to individually monitor the remote clinical analyzer at the remote setting to determine changes in the operation of the analyzer relative to adequacy of calibration or the need for the adjustment of parameter values when changing lots of reagents or detection devices such as MicroSlides™. Using the data forwarded to the Remote Monitoring Center, the same or alternative statistics can be calculated and downloaded to the remote site either upon demand or at prescheduled intervals.

The numerical values of these statistics can subsequently be used as baseline values for Shewhart charts, Levey-Jennings charts, or Westgard rules. Such methodology is described in both James O. Westgard and in Carl A. Burtis et al. previously incorporated by reference above.

Subsequent to the collection of the baseline data, operational data is collected for a particular diagnostic clinical analyzer over a specified sequence of second time periods and is sent over the network 113 to the general-purpose computer 112 at the end of each time period, denoted by network data flows 108, 109, 110, and 111. The data consists of numerous second time period values for operational error, operational range, and operational ratio. For the sequence of values associated with a specific operational variable, i.e., operational error, operational range, and operational ratio, the values are normalized by multiplying by 100 and dividing by the associated baseline control chart limit for that variable which was calculated previously. The general-purpose computer 112 is programmed to calculate the average value of these three normalized operational variables for to obtain the operational composite value for a sequence of second time periods. These values of the operational composite computed over a sequence of second time periods represent a time-series of observations. The operational composite value, the second statistic computed, is a statistic whose magnitude is indicative of the overall fluctuation in a particular diagnostic clinical analyzer's error budget. It should be noted that alternative preferred embodiments may use statistics that are not robust, but are based upon incomplete or fragmentary information. The general-purpose computer 112 stores and tracks these values, as indicated by the values 202 plotted in FIG. 2, and when the value of the operational composite is greater than the trimmed baseline composite control chart limit 201, as determined from the baseline data, for a predetermined number of second time periods over a predetermined time horizon, the Remote Monitoring Center is notified that there is an impending analytical failure of that particular analyzer. A detailed flowchart of the above baseline and operational computations is presented in FIG. 16.

The criteria stated above for determining when to alert for an impending analytical failure is significantly stricter than traditional statistical process control criteria. Specifically, the criteria being used in this methodology is when the value of the operational composite exceeds the trimmed baseline composite control chart limit 201 for two out of three consecutive observations. This is equivalent to exceeding the trimmed mean plus three times the trimmed standard deviation. As pointed out by John S. Oakland in Statistical Process Control, 6^{th} Edition, Butterworth-Heinemann, 2007, which is hereby incorporated by reference, the usual criteria for alerting that a process is out of control when using an individuals or run control chart is (1) an observation of the critical variable greater than the mean plus three standard deviations, (2) two out of three consecutive observations of the critical variable that exceed the mean plus two standard deviations, or (3) eight consecutive observations of the critical variable that either always exceed the mean or always are less than the mean. Hence, the criterion used in this methodology is much stricter, i.e., much less likely to occur, than the criteria normally employed. Employing this criterion has the result of reducing the number of false positives observed, where a false positive would be calling for an alert of an impending analytical failure when such an alert is not warranted. However, alternative preferred embodiments may use criteria as outlined above or alternative criteria as appropriate to reduce the number of false positives.

Operational statistics, like baseline statistics, may also be used to individually monitor the remote clinical analyzer at the remote setting to determine changes in the operation of the analyzer relative to adequacy of calibration or the need for the adjustment of parameter values when changing lots of reagents or detection devices such as MicroSlides™. Using the data forwarded to the Remote Monitoring Center, the statistics can be calculated and downloaded to the remote site either upon demand or at prescheduled intervals. The numerical values of these statistics can subsequently be analyzed using Shewhart charts, Levey-Jennings charts, or Westgard rules as data is received. Such methodology is described in both James O. Westgard and in Carl A. Burtis et al. previously incorporated by reference above.

The Remote Monitoring Center, upon notice that at least one remote diagnostic clinical analyzer has an impending analytical failure, must decide the appropriate follow up course of action to be employed. The techniques discussed herein allow the transformation of the gathered data and subsequently calculated statistics into an ordered series of actions by the Remote Monitoring Center management. The value of the second statistic, available for each remote diagnostic clinical analyzer where an impending analytical failure has been predicted, can be used to prioritize which remote analyzer should be serviced first as the relative magnitude of the second statistic is indicative of overall potential for failure for that analyzer. The higher the value of the second statistic, the greater the chance that an impending failure will occur. This is of significant value when the service resources are limited and it is desirable to make the most of such resources. Depending upon the distance of the remote diagnostic analyzer from a service site location, an on-site service call may take up to several hours. Part of this time is devoted to travel to the site (and return) plus the amount of time it takes to identify and replace one or more components of the diagnostic clinical analyzer that are starting to fail. Furthermore, if the notice of an impending failure is very timely, it may be possible to schedule an on-site service call to coincide with already scheduled downtime for the analyzer thereby preventing a disruption of analyzer uptime to the commercial entity employing the analyzer. For example, some hospitals collect patient samples so that many are analyzed from about 7:00 AM to 10:00 PM during the working day. It is most convenient for such hospitals to have the diagnostic clinical analyzers down from 10:00 PM to 7:00 AM. In addition, for the service site location, it is better to schedule service calls during routine working hours and certainly in advance of major holidays and other events.

Preferred embodiments for wet chemistries employing either cuvettes or microtitre plates is similar to the preferred embodiment above for thin-film slides except that a different set of variables is required to be monitored. However, the overall transformation of the baseline information to a first, robust statistic and the transformation of the operational data to a second statistic remains the same, as does the operation of the control chart. Exemplary examples of the implementation of this disclosure are described below.

### EXAMPLE 1

### 647 Analyzer

This example deals with the detection of impending analytical failure in dry chemistry MicroSlide™ diagnostic clinical analyzers using ion-specific electrodes as the assay-measuring device. On Aug. 12, 2008, data on three specific variables was obtained from a population of 862 diagnostic clinical analyzers over a time period of one day. The first variable is the percentage of all sodium, potassium, and chloride assays that resulted in non-zero error codes or conditions. The second variable is the average of the three voltage signal levels taken during the ion-specific electrode readout for all potassium assays. In addition, the third variable is the standard deviation of the ratio of the average signal analog-to-digital count to the average validation analog-to-digital count for all potassium assays. The signal analog-to-digital count is the voltage of the slide measured by the electrometer and the validation analog-to-digital count is the voltage of the slide taken with the internal reference voltage applied to the slide in series.

It should be noted for this and ensuing examples, that baseline and operational data values are obtained as double precision floating point values as defined by the IEEE Floating Point Standard 754. As such, these values, while represented internally in a computer using 8 digital bytes, have approximately 15 decimal digits of precision. This degree of precision is maintained throughout the sequence of numerical computations; however, such precision is impractical to maintain in textual references and in figures. For the purpose of this exposition, all floating-point numbers referenced in the text or in figures will be displayed to three decimal places rounded up or down to the nearest digit in the third decimal place without regard to the number of significant decimal digits present. For example, 123.456781234567 will be displayed as 123.457, and 0.00123456781234567 will be displayed as 0.001. This display mechanism has the effect of potentially yielding incorrect arithmetic if numerical quantities as displayed are used for computation. For example, multiplying the two 15 decimal digit numbers above yields 0.152415768327997 to 15 decimal digits of precision; however, if the two displayed representations of the two numbers are multiplied, then 0.123456 to 6 decimal digits is obtained. Clearly, the two values thus obtained are significantly different.

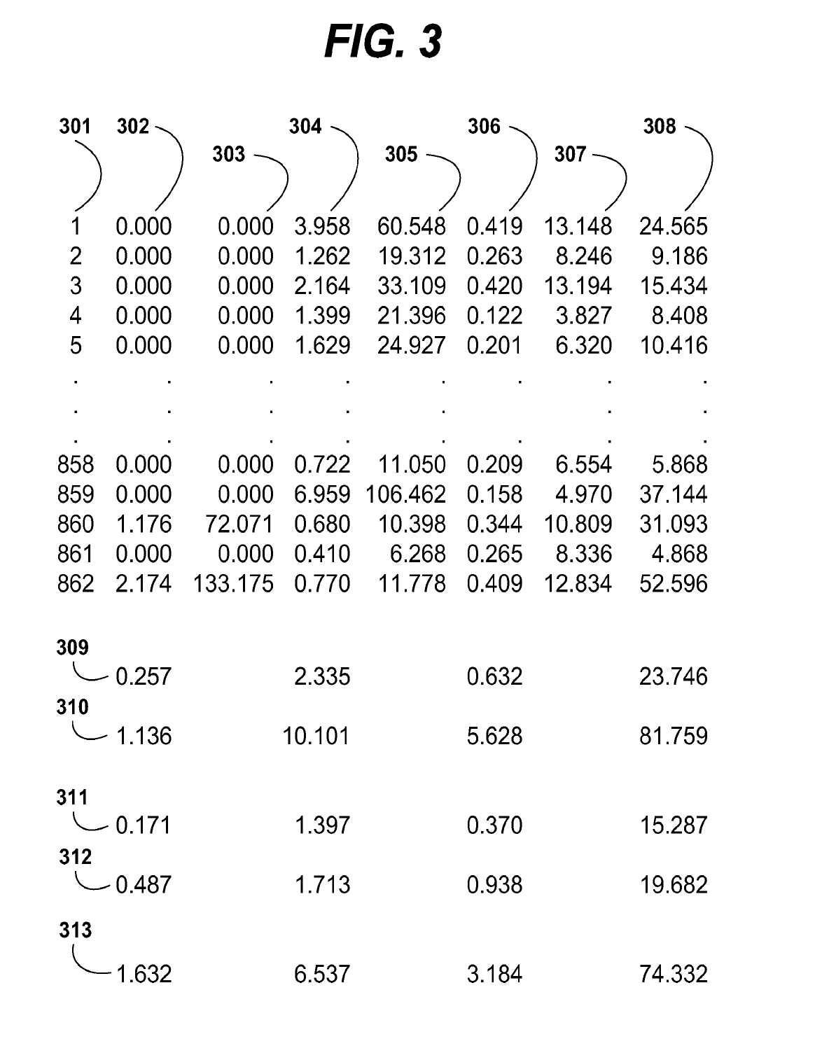

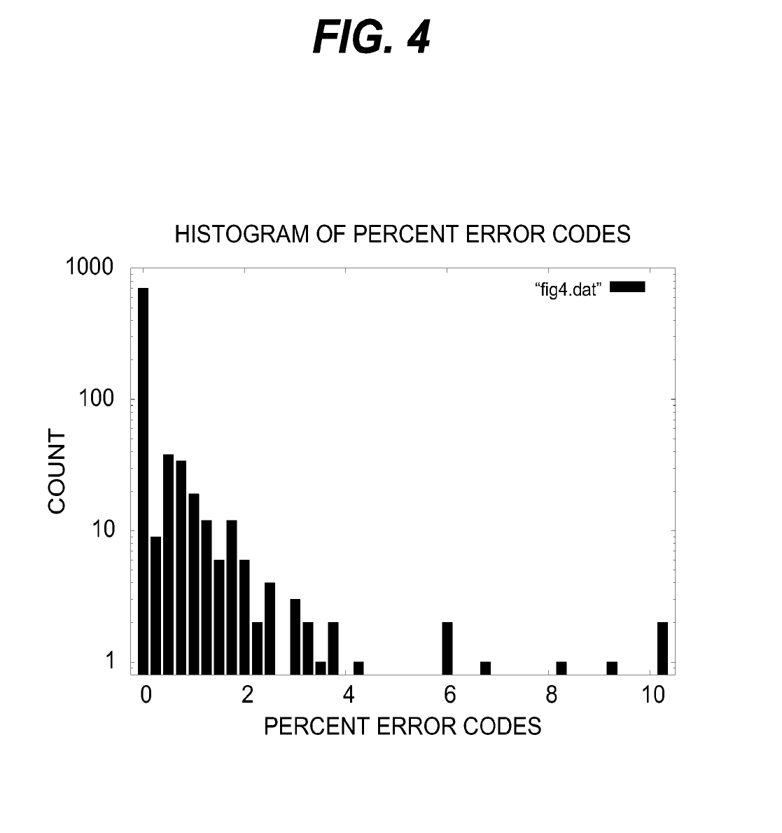

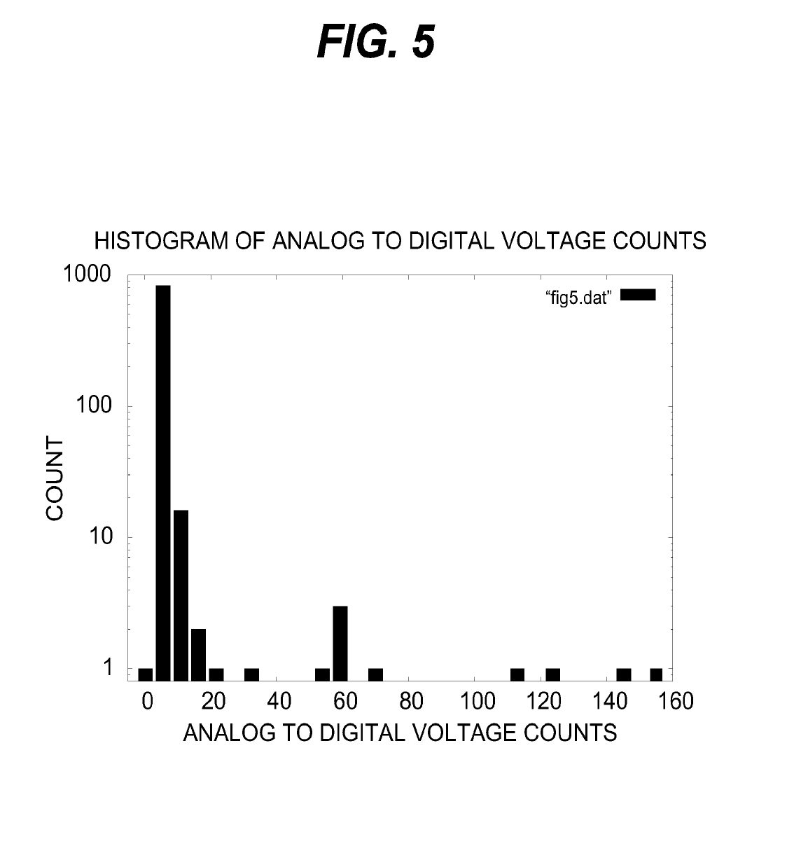

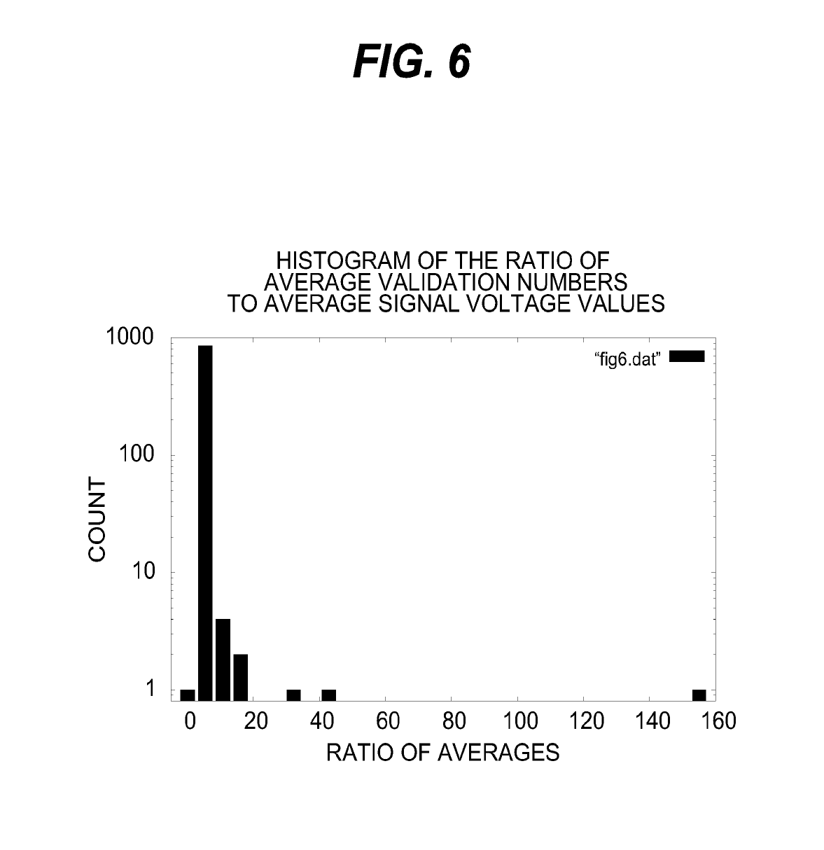

FIG. 3 contains the data setup for the computation of the control chart limit using the above baseline data. Column 301 denotes a specific diagnostic clinical analyzer in the population of 862 analyzers. Column 302 denotes the reported percent error codes by analyzer, i.e., baseline error1. Column 304 denotes the reported average of three voltage signal levels by analyzer, i.e., baseline range1. Column 306 denotes the reported ratio of the average value of the signal analog-to-digital count numbers to the average of the signal analog-to-digital count by analyzer, i.e., baseline ratio1. For each of the three reported columns of data, columns 302, 304, and 306, respectively, the mean is computed, as shown in row 309, and the standard deviation is computed, as shown in row 310. FIG. 4, FIG. 5, and FIG. 6 show a histogram of the reported baseline error1 values, the reported baseline range1 values, and the reported baseline ratio1 values for all the 862 reporting diagnostic clinical analyzers, respectively. In a process known as trimming, all baseline error1 values in column 302 not included in the range of the baseline error1 mean value of 0.257 plus or minus three times the baseline error1 standard deviation value of 1.136 are then removed. Trimmed baseline error1 mean values, shown in row 311, and trimmed baseline error1 standard deviation values, shown in row 312, are computed from the values remaining in column 302 after trimming. Similar trimming computations are performed for the baseline range1 and baseline ratio1 values. The resulting baseline error1 control chart limit value, baseline range1 control chart limit value, and baseline range1 control chart limit value, shown as the first three elements of row 313, are computed as the trimmed mean plus three times the trimmed standard deviation.

Each data value of baseline error1, in column 302, is then multiplied by 100 and divided by the baseline error1 control chart limit (the first element in row 313) to yield the normalized baseline error1 as shown in column 303. In a similar fashion, these computations are repeated for the data values of baseline range1, shown in column 304, and for the data values of baseline ratio1, shown in column 306, resulting in column 305 of normalized baseline range1 values and in column 307 of normalized baseline ratio1 values, respectively. Next, the baseline composite1 value in column 308 associated with an analyzer in column 301, is computed as the average value of the normalized baseline error1 in column 303, the normalized baseline range1 in column 305, and the normalized baseline ratio1 in column 307. The mean and standard deviation of the baseline composite1 in column 308 is then computed and shown as the fourth element of row 309 and row 310, respectively. Elements of column 308 not included in the range of the baseline composite1 mean plus or minus three baseline composite1 standard deviations are removed via trimming. Subsequently, the trimmed baseline composite1 mean, element four in row 311 of column 308, is computed using the baseline composite1 values remaining in column 308 after trimming. In addition, the trimmed baseline composite1 standard deviation, element four in row 312 of column 308, is computed using the baseline composite1 values remaining in column 308 after trimming. The trimmed baseline composite1 control chart limit value, the first statistic calculated, is then computed as the trimmed baseline composite1 mean plus three times the trimmed baseline composite1 standard deviation, the result being shown as element four in row 313 of column 308.

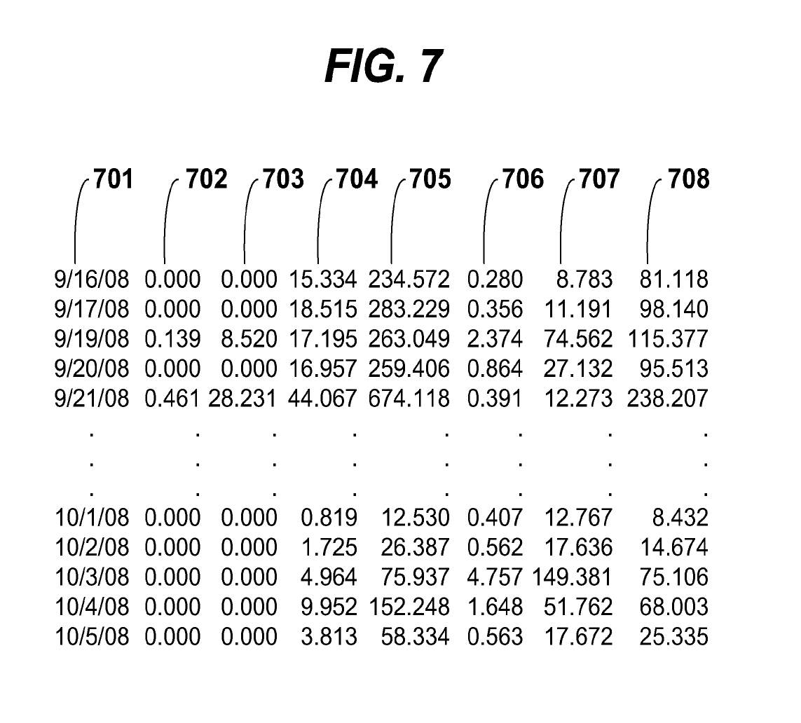

FIG. 7 contains the data setup for the daily operational data reports from the 647 analyzer displayed as rows of data. Column 701 denotes the date on which the data was taken. Columns 702, 704, and 706 denote reported values of operational error1, operational range1, and operational ratio1, respectively.

Columns 703, 705, and 707 are the computed normalized values of operational error1, operational range1, and operational ratio1, respectively, obtained by multiplying columns 702, 704, and 706 by 100 and then dividing by the trimmed baseline error1 mean value, trimmed baseline range1 mean value, and trimmed baseline ratio1 mean value, respectively. Column 708 contains values of the operational composite1 value, the second statistic calculated, obtained by averaging the values in columns 703, 705, and 707.

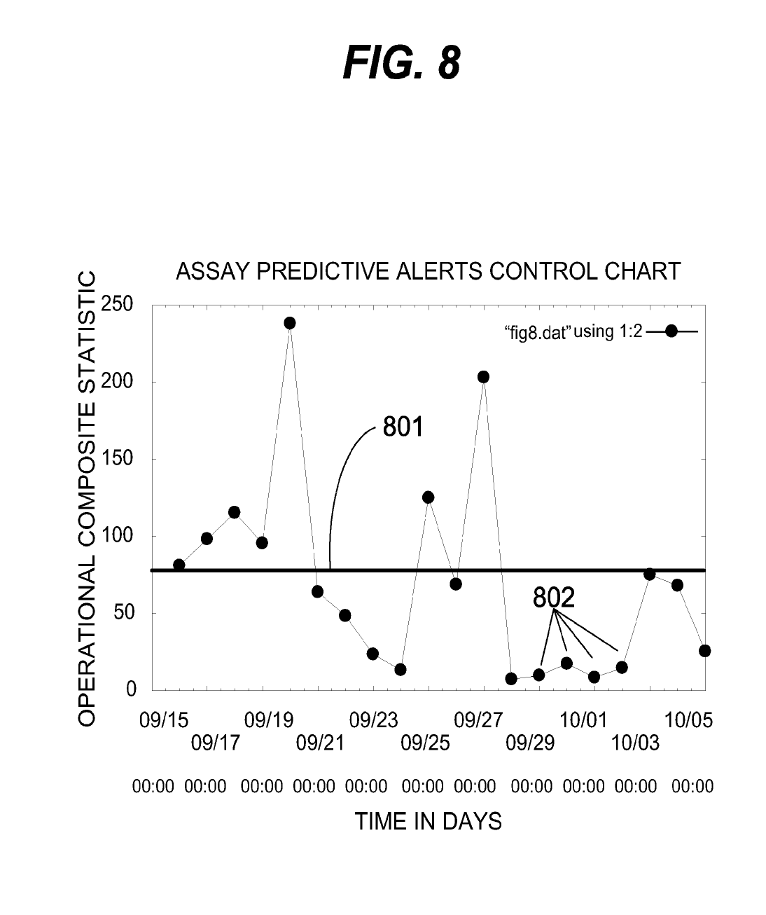

FIG. 8 contains the 647 diagnostic clinical analyzer control chart where each value of the operational composite1 in column 708 is plotted as dots 802. The line 801 represents the trimmed baseline composite1 control chart limit value of 74.332. Note that the daily operational composite1 value starts out near the control chart limit value and then exceeds it for three days but subsequently drops below the control limit value. This would be the first indication of an impending analytical failure by the diagnostic clinical analyzer. After several more days, the operational composite1 value once again exceeds the control chart limit for two days out of three. While still showing no outward signs of operational problems, a service technician was dispatched to the analyzer site and, after careful analysis, the electrometer was found to be slowly failing. The electrometer was replaced on September 28^{th}. Subsequently, for the duration of this test data, values of operational composite1 remained below the control chart limit.

### EXAMPLE 2

### 267 Analyzer

This example deals with the detection of impending analytical failure in wet chemistry MicroTip™ diagnostic clinical analyzers using a photometer to measure the absorbance through the sample as the assay-measuring device. On Nov. 13, 2008, data on four specific variables was obtained from a population of 758 diagnostic clinical analyzers over a time period of one day. The first variable is the standard deviation of the error in the incubator temperature, defined as the baseline incubator2 value, as measured hourly. The second variable is the standard deviation of the error in the MicroTip™ reagent supply temperature, defined as the baseline reagent2 value, as measured hourly. The third variable is the standard deviation of the ambient temperature, defined as the baseline ambient2 value, as measured hourly. In addition, the fourth variable is the percent condition codes of the combined secondary metering and three read delta check codes, defined as the codes2 value.

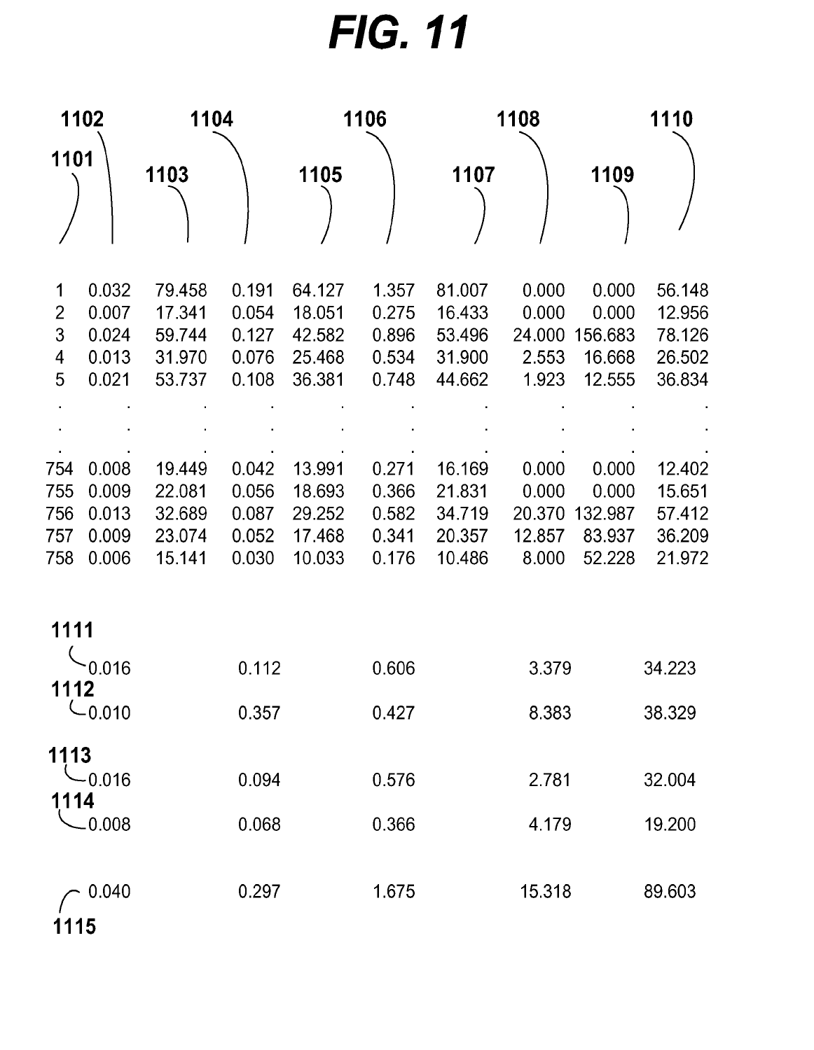

Subsequently, the trimmed baseline composite2 control chart limit value for this example is computed in the same manner as was employed to compute the trimmed baseline composite1 control chart limit value in Example 1. The data structure is shown in FIG. 11 where column 1101 denotes the analyzer providing the baseline data, columns 1102, 1104, 1106, and 1108 are values of baseline incubator2, baseline reagent2, baseline ambient2, and baseline codes2, respectively. Normalized values of the input values of baseline incubator2, baseline reagent2, baseline ambient2, and baseline codes2 are shown in columns 1103, 1105, 1107, and 1109, respectively. Rows 1111 and 1112 contain the mean and standard deviation, respectively, of columns 1102, 1104, 1106, and 1108, respectively. Rows 1113 and 1114, respectively, contain the trimmed mean and trimmed standard deviation of columns 1103, 1105, 1107, and 1109, respectively. Element 5 in row 1115 of column 1110 is the value of the trimmed baseline composite2 control chart limit value, the first statistic calculated, specifically 89.603.

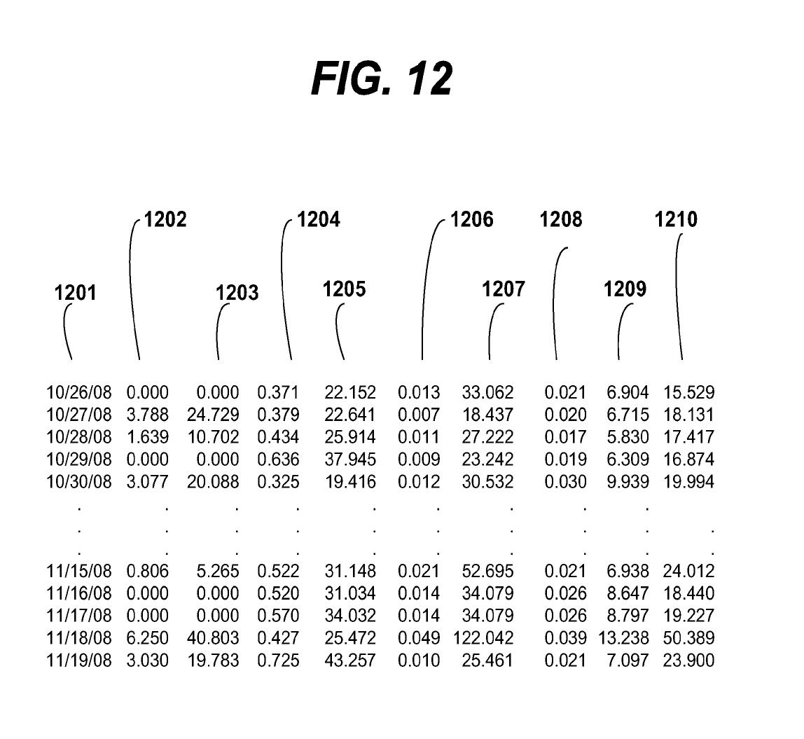

FIG. 12 contains the data setup for the daily operational data reports from the 267 analyzer displayed as rows of data. Column 1201 contains the date on which the data was taken. Column 1202, 1204, 1206, and 1208 contain the reported daily values of the operational incubator2, operational reagent2, operational ambient2, and operational codes2 values, respectively. Columns 1203, 1205, 1207, and 1209 are normalized values of the four values of operational incubator2, operational reagent2, operational ambient2, and operational codes2, respectively, obtained in the same manner as values of operational values were in Example 1. Column 1210 contains values of the daily operational composite2 value, the second statistic calculated.

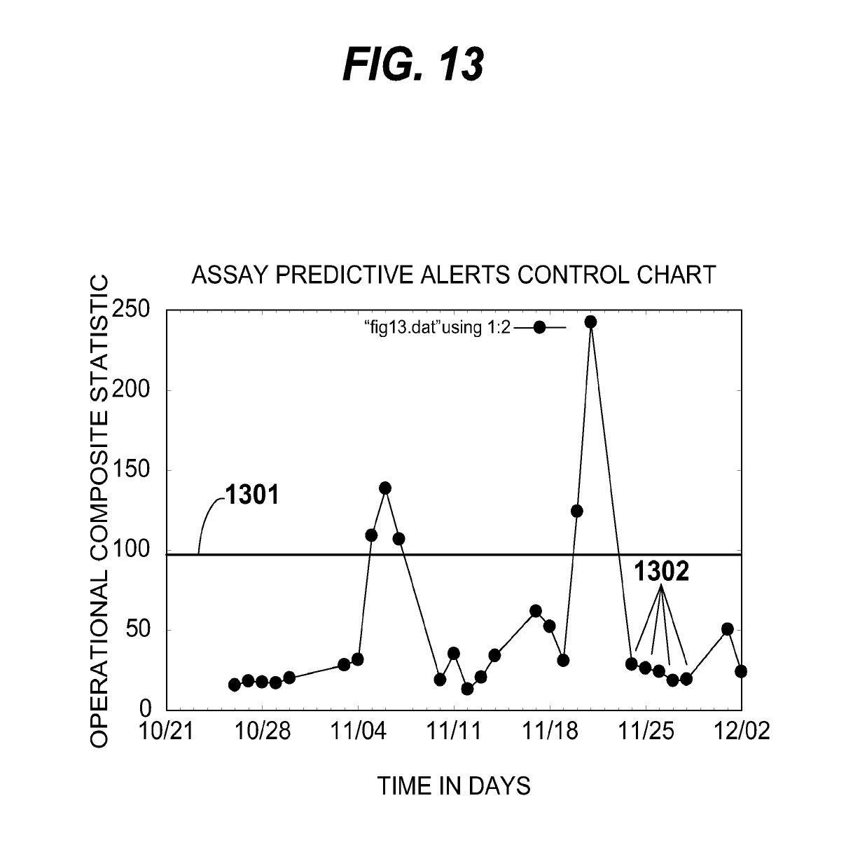

FIG. 13 contains the 267 diagnostic clinical analyzer control chart where each value of the operational composite2 in column 1210 is plotted as dots 1302. The trimmed baseline composite2 control chart limit value of 89.603 is represented by the line 1301. Note that the daily operational composite2 value starts out at a low value for 7 days then jumps up to exceed the control limit for 3 days. After returning to a low value for eight more days, the operational composite2 value once again exceeds the control chart limit for two days out of three. Both of the above events would result in an alert regarding an impending analytical failure. Subsequently, for the duration of this test data, values of daily operational composite2 remained below the control chart limit.

### EXAMPLE 3

### 406 Analyzer

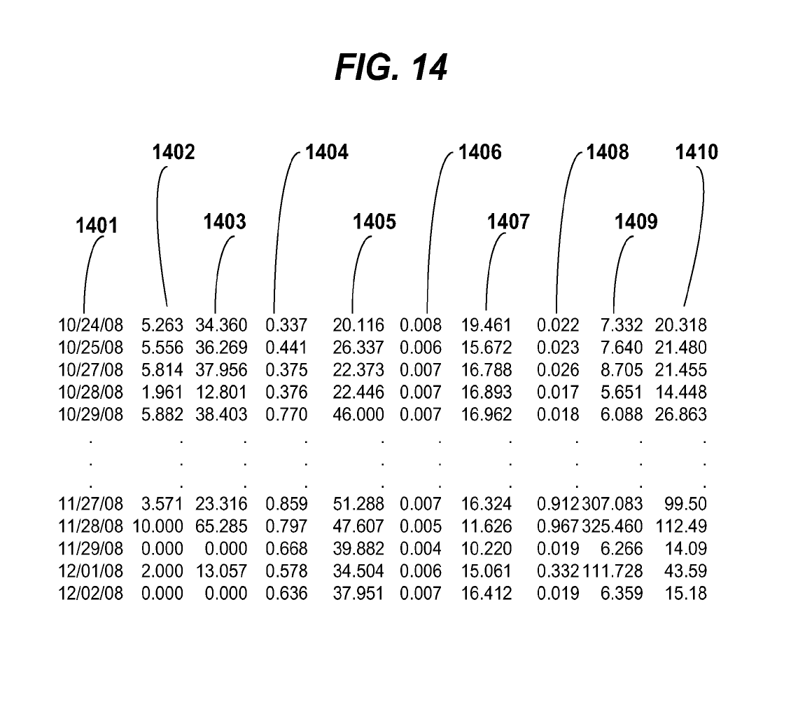

This example deals with the detection of impending analytical failure in wet chemistry MicroTip™ diagnostic clinical analyzers using a photometer to measure the absorbance through the sample as the assay-measuring device. Using the Example 2 baseline data obtained on Nov. 13, 2008, operational data for the 406 analyzer were obtained on a daily basis from Oct. 24, 2008 to Dec. 2, 2008 as shown in FIG. 14.

Column 1401 contains the date on which the data was taken. Column 1402, 1404, 1406, and 1408 contain the reported daily values of the operational incubator3, operational reagent3, operational ambient3, and operational codes3, respectively. Columns 1403, 1405, 1407, and 1409 are normalized values of the four values of operational incubator3, operational reagent3, operational ambient3, and operational codes3, respectively, obtained in the same manner as values of operational variables were in Example 1. Column 1410 contains values of the daily operational composite3 value, the second statistic calculated.

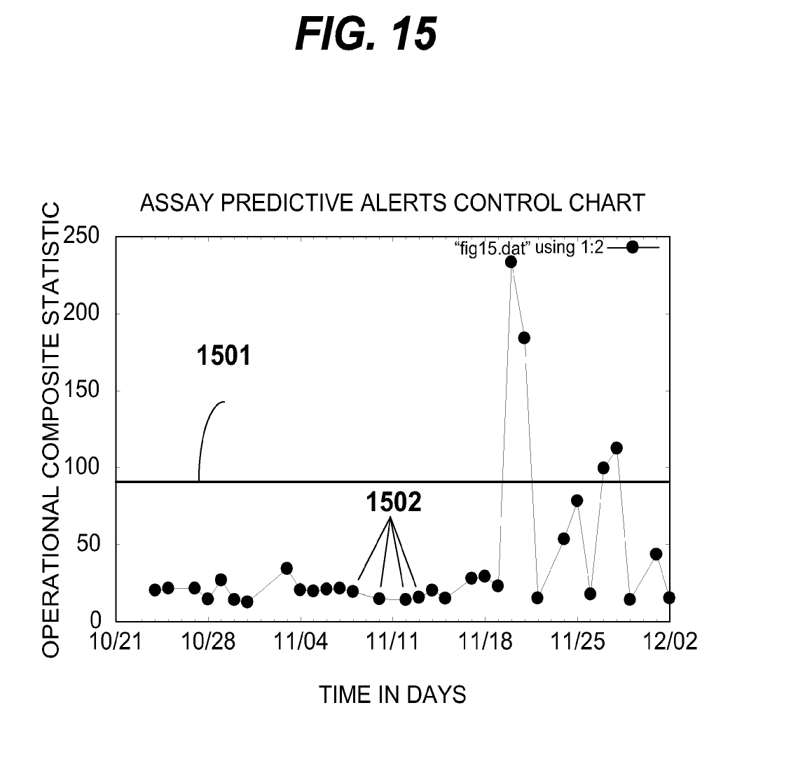

FIG. 15 contains the 406 diagnostic clinical analyzer control chart where each value of the operational composite3 in column 1410 is plotted as dots 1502. The trimmed baseline composite3 control chart limit value of 89.603 is represented by the line 1501. Note that the daily operational composite3 value starts out at a low value for many days then jumps up to exceed the control limit for two out of three days on Nov. 20, 2008. After returning to a low value for a couple more days, the operational composite3 value once again exceeds the control chart limit for two days out of three. Both of the above events would result in an alert regarding an impending analytical failure. Subsequently, for the duration of this test data, values of daily operational composite3 remained below the control chart limit.

### EXAMPLE 4

### Assay Precision Flagged by Detection of Impending Failure

This example demonstrates the higher imprecision in the results generated by MicroTip™ diagnostic clinical analyzers that more frequently flag an impending failure. The detection of impending failures not only makes fixing failures faster, it also allows for better performance in the assays by flagging analyzers most likely to have less than perfect assay performance. Such improvements are otherwise difficult to make because often an assay result examined in isolation appears to meet the formal tolerances set for the assay. Detecting that the variance in the assay results reflect increased imprecision allows measures to be taken to reduce the variance and, as a result, increase the reliability of the assay results.

Increased imprecision was demonstrated by identifying analyzers that most frequently triggered the alerts. To this end, seven hundred and forty-one networked clinical analyzers were used to collect baseline data on December 10 through December 12 in 2008. Eight variables were tracked for each analyzer, viz., (i) Slide Incubator Drag (‘Slide Inc Drag’), (ii) Reflection Variance (‘Refl. Var.’), (iii) Ambient Variance (‘Ambient Var.’), (iv) Slide Incubator Temp Variance (‘Slide Inc. Temp. Var.’), (v) Lamp Current (‘Lamp Current’), (vi) Codes/Usage—per cent of sample metering codes relative to the number of slides processed-detecting metering suspect according to system (‘Codes/Usage’), (vii) Delta DR (CM) diff between two readings on CM assay 9 sec apart counting number of events that are different by more than a specified threshold (‘Delta DR(CM)’), and (viii) Delta DR (Rate) (‘Delta DR(Rate)’), which looks at two points and identifies assays below a concentration level to detect noise below a regression line.

The baseline data were processed as represented in FIG. 16 to calculate the mean and standard deviation for each of the above variables followed by trimming to remove values that were more than three standard deviations away from the mean by dropping such entries. The remaining variable entries were processed to compute a trimmed mean and trimmed standard deviation for each of the eight variables. The sum of the mean and three standard deviations of the trimmed variable was used to normalize the variable values as described earlier. This implementation choice is not intended to and should not be understood to be a limitation on the scope of the invention unless such is expressly indicated in the claims. The normalization factor, sum of the mean and three standard deviations of the trimmed variables, is used as a threshold for the variable to flag unusual changes in operational data and assist in trouble shooting and servicing clinical diagnostic analyzers. Thus, such a threshold was calculated for each of the eight monitored variables from the baseline data. The normalized values for all of the variables were combined to compute the Baseline Composite Control Chart Limit, which is used to flag impending failures. In this example if an analyzer exceeded the Baseline Composite Control Chart Limit, it was flagged for an impending failure. This implementation choice is not intended to and should not be understood to be a limitation on the scope of the invention unless such is expressly indicated in the claims. The thresholds for the each of the eight monitored variables and the Baseline Composite Control Chart Limit—all derived from the baseline data—are shown in TABLE 1. These thresholds were also used to subsequently normalize each of the variables for computing the Baseline Composite Control Chart Limit, which was determined to be 104.79—the value used to evaluate all eight variables together to detect an impending failure—and which helped launch a more detailed inquiry into the type of service or corrections required by looking at the individual variables.

TABLE 1
showing the thresholds for the eight monitored variables

| | | |
|---|---|---|
| 1 | Slide Inc Drag | 160 |
| 2 | Refl. Var. | 0.0780 |
| 3 | Ambient Var. | 1.0 |
| 4 | Slide Inc. Temp. Var. | 0.047 |
| 5 | Lamp Current' | −0.89 |
| 6 | Codes/Usage | 0.67 |
| 7 | Delta DR(CM) | 1.3 |
| 8 | Delta DR(Rate) | 0.00037 |

Using operational data, for selected colorimetric assays twelve (12) clinical diagnostic analyzer systems were identified that triggered the Alert most frequently during November and December of 2009. These were compared to twelve (12) clinical diagnostic analyzer systems that triggered the Alert least frequently by comparing the assay performance on known Quality Control (‘QC’) reagents. Ideally, such reagents should result in similar readings with similar variances. A pooled standard deviation was performed on both populations (the twelve clinical diagnostic analyzer systems triggering the Alerts most often and those triggering the Alerts least often). Instead, clinical diagnostic analyzer systems triggering the alert were found to also exhibit elevated imprecision (worse assay performance). Thus, clinical diagnostic analyzer systems triggering the alert also show elevated imprecision. Example data for the Calcium (‘Ca’) assay in TABLE 2 show the identifiers for five ‘bad’ diagnostic clinical analyzers, the number of times Quality Control reagents were measured on each of them, the mean, the Standard Deviation, and the Coefficient of Variation followed by similar numbers for five ‘good’ clinical diagnostic analyzers.

TABLE 2
POOLED IMPRECISION COMPARISON CALCIUM ASSAY DATA
FROM MOST AND LEAST ALERTING MACHINES

| Machine ID | N | Mean (mg/dL) | SD (mg/dL) | % CV |
|---|---|---|---|---|
| 34000822 | 34 | 11.94 | 0.41 | 3.41 |
| 34000466 | 28 | 12.01 | 0.13 | 1.04 |
| 34000487 | 44 | 11.77 | 0.09 | 0.80 |
| 34001405 | 25 | 11.7 | 0.19 | 1.67 |
| 34001056 | 22 | 11.6 | 0.15 | 1.32 |
| Pooled Imprecision | | 11.79 | 0.22 | 1.65 |
| for bad machines | | | | |
| 34000426 | 25 | 11.98 | 0.11 | 0.91 |
| 34001817 | 24 | 12.34 | 0.16 | 1.3 |
| 34000737 | 31 | 12.29 | 0.08 | 0.69 |
| 34001726 | 32 | 12.07 | 0.1 | 0.84 |
| 34000478 | 31 | 11.78 | 0.11 | 0.97 |

| | | | |
|---|---|---|---|
| Pooled Imprecision | 12.09 | 0.12 | 0.94 |
| for good machines | | | |

Similar data were collected for different assays such as Iron (Fe), Magnesium (Mg) and the like.

Analyzers were selected based on similar QC. Since customers run QC fluids from various QC manufacturers, analyzers were identified that had similar means (indicating the same manufacturer) for QC reagents for multiple assays. It is useful to appreciate that the term ‘impending failure’ does not require similarly degraded performance for different assays. While ALB (for albumin) assays on Analyzer 1 may run the same QC reagents for ALB as Analyzer 2, Analyzer 1 may be using a different QC fluid for Ca assays and thus may differ from Analyzer 2. Therefore, at least five (5) (out of the twelve (12)) analyzers were identified that ran QC with a similar mean (manufacturer or comparable performance) for each assay. As a result, analyzers identified as the five ‘bad’ or the five ‘good’ analyzers were not the same for all assays. The worst analyzer for Fe assays may not be the worst for Mg assays based on the frequency of triggering alerts.

### EXAMPLE 5

### Assay Yield Affected by Impending Failures

This example uses the analyzers and data described in Example 4. Another examined measure in those analyzers was the First Time Yield (FTY), which refers to the number of acceptable assays as a fraction of all of the assays run on the analytical analyzer in a time period.

Unlike the variance measured with QC reagents, the FTY measure examines the performance of actual assays on clinical diagnostic analyzers. A low FTY value indicates that many assay results are being rejected by assay failure detection systems and procedures—as opposed to the detection of an impending failure of the system rather than a particular assay—which often requires repeating the assay and reduces the throughput. Typically, an FTY value of 90% or better, and typically better than 94% is expected for diagnostic clinical analyzers. FTY was also compared for 5 “good” (with the highest FTY) and 5 “bad” (with the lowest FTY) systems with the “bad” systems experiencing a lower FTY.

Example data in TABLE 3 below show the identifiers for five ‘Bad’ diagnostic clinical analyzers, the number of assays run on each of them, the respective first time yields followed by similar numbers for ‘Good’ clinical diagnostic analyzers.

TABLE 3
RELATIONSHIP BETWEEN FTY AND FREQUENCY OF ALERTS

| | Machine ID | N (# of assays run) | FTY (%) |
|---|---|---|---|
| Bad | 34000466 | 109557 | 97.9 |
| Bad | 34000487 | 51047 | 97.5 |
| Bad | 34000822 | 46019 | 94.2 |
| Bad | 34001405 | 17403 | 90.2 |
| Bad | 34000686 | 62900 | 89.0 |
| Good | 34001656 | 12099 | 98.7 |
| Good | 34001726 | 11636 | 98.6 |
| Good | 34000377 | 48352 | 98.1 |
| Good | 34000737 | 20837 | 98.0 |
| Good | 34000426 | 31877 | 97.9 |

As is readily seen, there is a reduction in FTY for ‘bad’ (high-alert frequency) analyzers. Thus, correcting for impending failures is desirable to improve FTY.

### EXAMPLE 6

### Assay Yield Affected by Elevated Average Alert Values

This example uses the analyzers and data described in Example 4. Using operational data, for selected colorimetric assays ten (10) clinical diagnostic analyzer systems were identified that exhibited high average Alert Values (which is compared to the Baseline Composite Control Chart Limit to generate an Alert) and compared to twelve (12) clinical diagnostic analyzer systems that had a low average Alert Value. For this analysis the Alert Value for an analyzer triggering the Alert was not counted—in other words, the triggering value was discounted—when comparing the assay performance on known Quality Control (‘QC’) reagents. Systems triggering the alert can have a small number of triggered values that can be very large and artificially elevate the average. For this method the alert values when the Alert was triggered were discounted to identify systems that had an elevated mean value. This is very similar to Example 4, but includes some systems that had an elevated mean Alert Value but would not have triggered the alert for all of the elevated Alert Values.

As noted previously, ideally, QC reagents should result in similar readings with similar variances. A pooled standard deviation was performed on both populations showing that systems that had a high average Alert Value show elevated imprecision as compared to systems that had a lower average Alert Value. First Time Yield data was also compared for 5 “good” and 5 “bad” systems in a manner otherwise similar to the analysis in Example 5. The “bad” systems were found to have a lower FTY. Thus, clinical diagnostic analyzer systems with elevated mean alert values also show elevated imprecision.

### EXAMPLE 7

### Alert Value Levels on a Single Analyzer Reflect Assay Imprecision

This example also uses an analyzer similar to those described in Example 4. QC reagents based data was evaluated for all CM assays on a single system. The analyzer performance in a time period when the system was exceeding the Alert limit was compared to the analyzer performance during a time period when it was not exceeding the Alert limit. Such a comparison ensures similar environment, operator protocol, and reagents and allows evaluation of the utility of the detection of impending failures. This method provides a gauge to measure performance differences in assay results (i.e. QC results).

An F-Test at the 95% level of confidence for each Chemistry/QC fluid combination, indicated that the studied analyzer when ‘BAD’ shows degraded chemistry imprecision for at least one of the two QC levels per chemistry compared to the analyzer when ‘GOOD’ for 27 (96.4%) of the 28 chemistries in the data set. These are shown in TABLE 4 with the ‘FALSE’ label, indicating when the variance was greater for the ‘GOOD’ analyzers than for the ‘BAD’ analyzers, shown in bold.

More specifically, for every chemistry except one, at least one of the QC fluids had a QC Variance greater when analyzer was ‘BAD’ than when the Analyzer was ‘GOOD’. This indicates, using the two QC levels as an indicator for imprecision, the analyzer when in its ‘BAD’ phase tends to show degraded chemistry performance compared to the analyzer when ‘GOOD’.

It is useful to examine how a field engineer or the hot line will be assisted by this disclosure in providing help more quickly through the use of the assay predictive alert information. An analyzer that is consistently about the Baseline Composite Control Chart Limit may be selected for proactive repair or the information associated with the assay predictive alert can be used in a reactive mode when a customer calls about assay performance concerns. If the composite alert is above the threshold, which indicates that one or more of the underlying variables are abnormal, a preferred process to identify a cause is to look at the individual variables. For instance, in Example 4 there are eight individual variables that make up the Alert Value (which is compared to the Baseline Composite Control Chart Limit). Each of these variables has a threshold, which in a preferred embodiment was used to both trim data and to normalize the values of the variables. Being above the threshold indicates that the variables represents an aberrant subsystem or performance. When only one monitored variable is abnormal the field engineer can focus on this portion of the clinical diagnostic analyzer. In sharp contrast presently assay performance issues typically require multiple visits and assistance from regional specialists to just identify the subsystem that is the primary cause. Therefore, the impending alert capability can save the customer from living with degraded performance for days or weeks before it is resolved. Customers in this situation often stop running assays that have poor performance (based on the control process that they use) on one system and move these assays to an analyzer in that lab or if necessary to a different hospital until the issue is resolved.

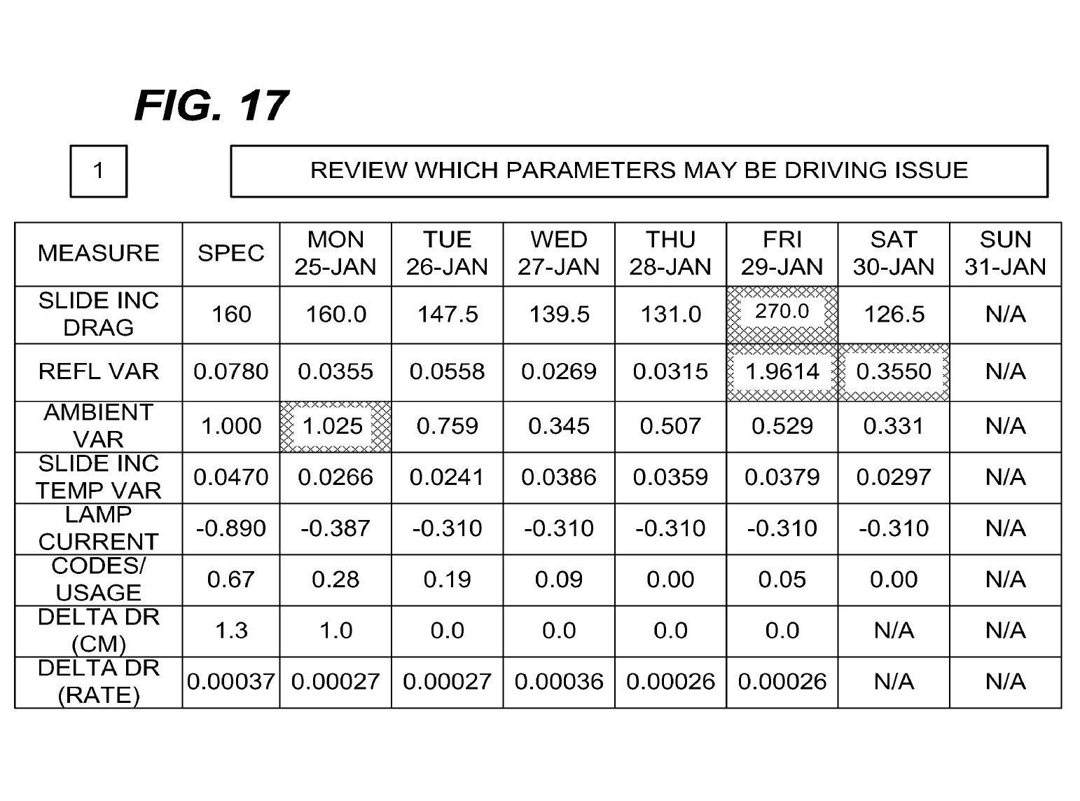

FIG. 17 shows an exemplary screen shot based on the data and thresholds from Example 4. The schematic shows a listing of various monitored variables, their respective thresholds and the values on various time points. When the individual thresholds are exceeded (not necessarily resulting in triggering an alert for an impending failure), the variable is flagged. For flagging, different colors, flashing values and other techniques may be used as is well known to those having ordinary skill in the art.

It should also be noted the correlation between Alert Values and assay precision is unlikely to be perfect. Examples 4 through 7 show that with Alert Values correlated with assay performance as seen in the control precision and to a lesser extent also with FTY. The reason for expecting a less than perfect correlation is that the assay control data is influenced by many factors that are unrelated to analyzer hardware performance. The control precision is influenced by operator error driven by factors like control fluid dilution error (since most control fluids require reconstitution), control fluid handling (evaporation, improper mixing, improper fluid warm-up prior to use) and chemical assay inherent imprecision (which may be abnormally high for this lot or section of the lot). Knowing that the customer is complaining about assay performance where the assay predictive alert is well below the composite threshold is useful since this enables the field engineer or hot line personnel to be a lot more confident that the issues are not caused by the analyzer. Then a careful review of the customer protocol is called for, which is usually challenging because it is often difficult to convince the customer that something they are doing is responsible for the observed imprecision. Having data to demonstrate that the analyzer hardware that influences this assay grouping's performance is performing well within expectations should make it easier to convince the customer to accept suggestions to change or review their procedures and processes.

TABLE 4
SHOWS THE PERFORMANCE OF SEVERAL ASSAY QUALITY CONTROL REAGENTS ON A SINGLE
ANALYZER IN ITS ‘BAD’ AND ‘GOOD’ PHASES TO DEMONSTRATE THE VALUE OF DETECTING
IMPENDING FAILURES

| | | | Bad | | | | | Good | | | | | |
|---|---|---|---|---|---|---|---|---|---|---|---|---|---|
| | | | Dec. 9, 2009-Jan. 3, 2010 | | | | | Nov. 20, 2009-Dec. 9, 2009 | | | | | SD Bad > SD |
| | | | | | | Variance | | | | Variance | | | Good @ |
| Chem | Units | Fluid | Mean | SD | % CV | (SD Sqrd) | # of Tests | Mean | SD | (SD Sqrd) | % CV | # of Tests | 95% Confidence |
| ALB | g/dL | 2 | 4.5 | 0.07 | 1.63 | 0.0049 | 63 | 4.5 | 0.05 | 0.0025 | 1.15 | 47 | TRUE |
| ALB | g/dL | 1 | 2.54 | 0.26 | 10.52 | 0.0676 | 59 | 2.49 | 0.02 | 0.0004 | 1.12 | 47 | TRUE |
| ALKP | U/L | 2 | 512.27 | 13.13 | 2.56 | 172.3969 | 57 | 516.39 | 13.84 | 191.5456 | 2.68 | 44 | FALSE |
| ALKP | U/L | 1 | 113.35 | 35.14 | 31 | 1234.8196 | 54 | 108.79 | 2.18 | 4.7524 | 2 | 41 | TRUE |
| ALT | U/L | 2 | 207.05 | 4.25 | 2.05 | 18.0625 | 54 | 206.57 | 3.96 | 15.6816 | 1.92 | 41 | FALSE |
| ALT | U/L | 1 | 34.64 | 11.63 | 33.57 | 135.2569 | 54 | 34.19 | 2.8 | 7.84 | 8.2 | 41 | TRUE |
| AMYL | U/L | 2 | 339.73 | 9.03 | 2.65 | 81.5409 | 60 | 342.82 | 11.39 | 129.7321 | 3.32 | 46 | FALSE |
| AMYL | U/L | 1 | 87.77 | 29.5 | 33.61 | 870.25 | 55 | 84.82 | 2.3 | 5.29 | 2.71 | 42 | TRUE |
| AST | U/L | 2 | 218.52 | 3.8 | 1.74 | 14.44 | 55 | 219.42 | 4.23 | 17.8929 | 1.92 | 43 | FALSE |
| AST | U/L | 1 | 42.01 | 25.97 | 61.81 | 674.4409 | 54 | 39.07 | 0.59 | 0.3481 | 1.52 | 41 | TRUE |
| Bc | mg/dL | 2 | 4.3 | 0.15 | 3.49 | 0.0225 | 72 | 4.45 | 0.14 | 0.0196 | 3.28 | 57 | FALSE |
| Bc | mg/dL | 1 | 0.32 | 0.07 | 22.84 | 0.0049 | 77 | 0.38 | 0.06 | 0.0036 | 16.09 | 50 | FALSE |
| Bu | mg/dL | 2 | 10.12 | 0.24 | 2.46 | 0.0576 | 75 | 10.15 | 0.21 | 0.0441 | 2.15 | 57 | FALSE |
| Bu | mg/dL | 1 | 0.8 | 0.19 | 24.46 | 0.0361 | 83 | 0.74 | 0.03 | 0.0009 | 4.44 | 50 | TRUE |
| CHOL | mg/dL | 2 | 255.34 | 4.7 | 1.84 | 22.09 | 58 | 256.49 | 5 | 25 | 1.94 | 46 | FALSE |
| CHOL | mg/dL | 1 | 161.25 | 17.41 | 10.79 | 303.1081 | 54 | 158.82 | 1.77 | 3.1329 | 1.11 | 41 | TRUE |
| CK | U/L | 2 | 1005.4 | 35.92 | 3.57 | 1290.2464 | 58 | 1011.41 | 30.02 | 901.2004 | 2.96 | 41 | FALSE |
| CK | U/L | 1 | 198.33 | 28.17 | 14.2 | 793.5489 | 58 | 193.72 | 5.74 | 32.9476 | 2.96 | 42 | TRUE |
| CREA | mg/dL | 2 | 5.57 | 0.1 | 1.91 | 0.01 | 59 | 5.49 | 0.04 | 0.0016 | 0.77 | 41 | TRUE |
| CREA | mg/dL | 1 | 1.12 | 0.45 | 40.21 | 0.2025 | 54 | 1.05 | 0.01 | 0.0001 | 1.29 | 41 | TRUE |
| Ca | mg/dL | 2 | 11.74 | 0.16 | 1.37 | 0.0256 | 55 | 11.66 | 0.12 | 0.0144 | 1.11 | 41 | TRUE |
| Ca | mg/dL | 1 | 8.91 | 0.54 | 6.13 | 0.2916 | 54 | 8.77 | 0.1 | 0.01 | 1.16 | 41 | TRUE |
| Cl− | mmol/L | 2 | 106.75 | 1.56 | 1.46 | 2.4336 | 62 | 106.41 | 0.97 | 0.9409 | 0.91 | 41 | TRUE |
| Cl− | mmol/L | 1 | 83.11 | 5.72 | 6.88 | 32.7184 | 57 | 81.99 | 0.85 | 0.7225 | 1.04 | 41 | TRUE |
| DGXN | ng/mL | 2 | 1.92 | 0.08 | 4.52 | 0.0064 | 55 | 1.97 | 0.07 | 0.0049 | 3.71 | 41 | FALSE |
| DGXN | ng/mL | 1 | 0.96 | 0.41 | 43.16 | 0.1681 | 54 | 1.01 | 0.06 | 0.0036 | 6.25 | 41 | TRUE |
| ECO2 | mmol/L | 2 | 15.2 | 0.67 | 4.44 | 0.4489 | 57 | 14.2 | 1.06 | 1.1236 | 7.48 | 48 | FALSE |
| ECO2 | mmol/L | 1 | 24.12 | 2.76 | 11.45 | 7.6176 | 54 | 23.76 | 0.94 | 0.8836 | 3.95 | 47 | TRUE |
| Fe | ug/dL | 2 | 231.71 | 19.43 | 8.38 | 377.5249 | 87 | 237.85 | 7.65 | 58.5225 | 3.21 | 59 | TRUE |
| Fe | ug/dL | 1 | 111.92 | 14.2 | 12.69 | 201.64 | 87 | 115.8 | 4.24 | 17.9776 | 3.66 | 60 | TRUE |
| GGT | U/L | 2 | 351.14 | 5.84 | 1.66 | 34.1056 | 55 | 365.94 | 15.23 | 231.9529 | 4.16 | 47 | FALSE |
| GGT | U/L | 1 | 75.13 | 15.76 | 20.98 | 248.3776 | 53 | 73.77 | 1.52 | 2.3104 | 2.06 | 47 | TRUE |
| GLU | mg/dL | 2 | 296.76 | 5.17 | 1.74 | 26.7289 | 57 | 295.21 | 2.78 | 7.7284 | 0.94 | 47 | TRUE |
| GLU | mg/dL | 1 | 81.64 | 24.38 | 29.86 | 594.3844 | 56 | 77.52 | 1.17 | 1.3689 | 1.51 | 47 | TRUE |
| K+ | mmol/L | 2 | 5.77 | 0.08 | 1.5 | 0.0064 | 60 | 5.77 | 0.05 | 0.0025 | 1.03 | 41 | TRUE |
| K+ | mmol/L | 1 | 3.17 | 0.43 | 13.79 | 0.1849 | 55 | 3.1 | 0.03 | 0.0009 | 1.02 | 41 | TRUE |
| LDH | U/L | 2 | 554.57 | 13.11 | 2.36 | 171.8721 | 55 | 557.14 | 12.71 | 161.5441 | 2.28 | 41 | TRUE |
| LDH | U/L | 1 | 163.58 | 23.38 | 14.29 | 546.6244 | 54 | 162.2 | 5.67 | 32.1489 | 3.5 | 42 | TRUE |
| Li | mmol/L | 2 | 2.54 | 0.06 | 2.67 | 0.0036 | 59 | 2.52 | 0.05 | 0.0025 | 2.02 | 40 | FALSE |
| Li | mmol/L | 1 | 1.14 | 0.08 | 7.7 | 0.0064 | 57 | 1.13 | 0.03 | 0.0009 | 2.94 | 41 | TRUE |
| Mg | mg/dL | 2 | 4.4 | 0.06 | 1.56 | 0.0036 | 54 | 4.39 | 0.04 | 0.0016 | 1.07 | 42 | TRUE |
| Mg | mg/dL | 1 | 1.9 | 0.25 | 13.49 | 0.0625 | 54 | 1.87 | 0.03 | 0.0009 | 1.63 | 42 | TRUE |
| Na+ | mmol/L | 2 | 142.42 | 2.27 | 1.59 | 5.1529 | 68 | 142.2 | 1.31 | 1.7161 | 0.92 | 43 | TRUE |
| Na+ | mmol/L | 1 | 119.82 | 5.06 | 4.22 | 25.6036 | 59 | 119.06 | 0.92 | 0.8464 | 0.77 | 41 | TRUE |
| PHOS | mg/dL | 2 | 7.11 | 0.08 | 1.24 | 0.0064 | 55 | 7.09 | 0.07 | 0.0049 | 0.99 | 41 | FALSE |
| PHOS | mg/dL | 1 | 3.83 | 0.58 | 15.21 | 0.3364 | 54 | 3.76 | 0.02 | 0.0004 | 0.78 | 41 | TRUE |
| TBIL | mg/dL | 2 | 14.99 | 0.42 | 2.86 | 0.1764 | 75 | 15.29 | 0.46 | 0.2116 | 3.06 | 60 | FALSE |
| TBIL | mg/dL | 1 | 1.34 | 0.23 | 17.46 | 0.0529 | 80 | 1.3 | 0.08 | 0.0064 | 6.85 | 54 | TRUE |
| TRIG | mg/dL | 2 | 245.54 | 3.58 | 1.46 | 12.8164 | 55 | 245.75 | 2.42 | 5.8564 | 0.98 | 41 | TRUE |
| TRIG | mg/dL | 1 | 125.69 | 20.28 | 16.13 | 411.2784 | 54 | 123.64 | 1.6 | 2.56 | 1.29 | 41 | TRUE |
| UREA | mg/dL | 2 | 54.54 | 0.84 | 1.54 | 0.7056 | 57 | 54.66 | 0.83 | 0.6889 | 1.51 | 41 | FALSE |
| UREA | mg/dL | 1 | 20.54 | 3.16 | 15.38 | 9.9856 | 54 | 20.15 | 0.34 | 0.1156 | 1.68 | 41 | TRUE |
| URIC | mg/dL | 2 | 9.88 | 0.16 | 1.67 | 0.0256 | 57 | 9.83 | 0.1 | 0.01 | 1.06 | 41 | TRUE |
| URIC | mg/dL | 1 | 4.27 | 0.66 | 15.47 | 0.4356 | 56 | 4.16 | 0.04 | 0.0016 | 1.02 | 41 | TRUE |
| dHDL | mg/dL | 2 | 54.9 | 1.37 | 2.51 | 1.8769 | 55 | 55.27 | 1.13 | 1.2769 | 2.05 | 41 | FALSE |
| dHDL | mg/dL | 1 | 41.02 | 2.26 | 5.53 | 5.1076 | 54 | 40.96 | 0.79 | 0.6241 | 1.92 | 41 | TRUE |

It will be apparent to those skilled in the art that various modifications and variations can be made to the methods and processes of this invention. Thus, it is intended that the present invention cover such modifications and variations, provided they come within the scope of the appended claims and their equivalents.

The disclosure of all publications cited above is expressly incorporated herein by reference in their entireties to the same extent as if each were incorporated by reference individually.

### Appendix

### Error Budget Example

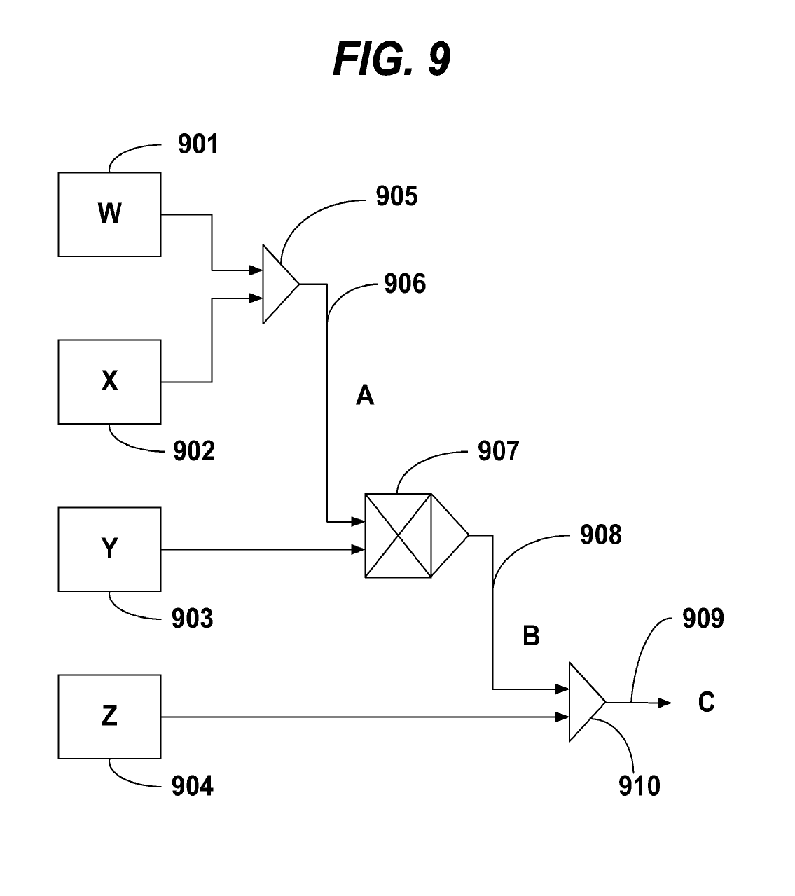

FIG. 9 displays a simple electronic circuit that has four input signals each having the characteristic of an independent random variable with known mean and known variance. The explicit characteristics of each signal is as follows:

W: E(W)=2.00

V(W)=0.10

X: E(X)=4.00

V(X)=0.40

Y: E(Y)=1.00

V(Y)=0.10

Z: E(Z)=2.00

V(Z)=0.50

where E( ) denotes the expected value and V( ) denotes the variance. Certainly, a casual review of the circuit diagram and the numerical characteristics of the signals gives little idea of input signal influence on the output signal variance. However, It is desired to determine the quantitative impact of each input signal on the variance of the output signal. The idea being that the greater influence an input signal has on the output signal then the smaller the error budget should be for that signal. Identifying those signals having the greatest impact on the output signal also provides a candidate list of signals to be monitored in the context of this application.

Given the explicit characteristics of each signal as provided above, the characteristics of signal A can be computed using known relationships for the expected value and variance of sums and products of independent random variables as found in H. D. Brunk, An Introduction to Mathematical Statistics, 2^{nd} Edition, Blaisdell Publishing Company, 1965, which is hereby incorporated by reference, and in Alexander McFarlane Mood, Franklin A. Graybill, and Duane C. Boes, Introduction to the Theory of Statistics, 3^{rd} Edition, McGraw-Hill, 1974, which is hereby incorporated by reference. Specifically,

E(A)=E(W+X)=E(W)+E(X)=6.00

V(A)=V(W+X)=V(W)+V(X)=0.50

Next, the characteristics of signal B can be determined as follows:

E(B)=E(A*Y)=E(A)*E(Y)=6.00

V(B)=V(A*Y)=E(A)²*V(Y)+E(Y)²*V(A)+V(A)*V(Y)=4.15

In addition, finally, the characteristics of signal C can be determined as follows:

E(C)=E(B+Z)=E(B)+E(Z)=8.00

V(C)=V(B+Z)=V(B)+V(Z)=4.65

however, knowing the explicit characteristics of signals A, B, and C does not indicate anything regarding the sensitivity of the variance of signal C to the input mean and variance of signals W, X, Y, and Z.

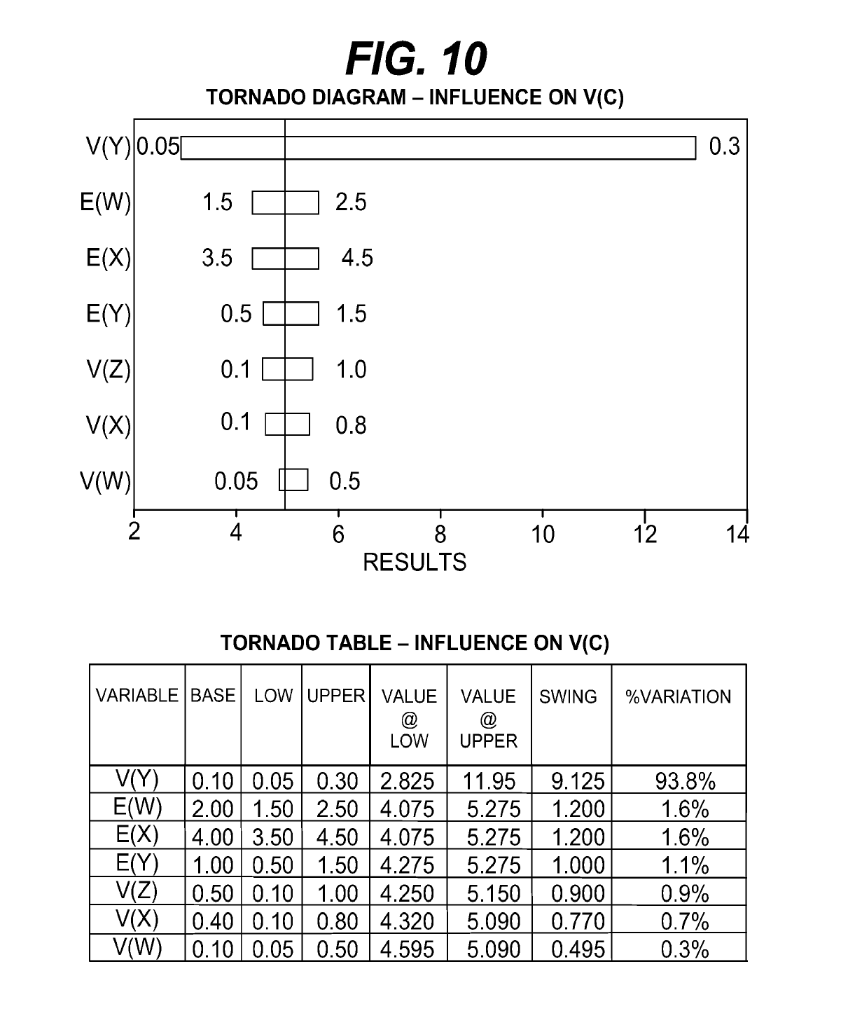

One way to obtain this sensitivity information is to use tornado tables or diagrams as explained by Ted G. Eschenbach, Spiderplots versus Tornado Diagrams for Sensitivity Analysis, Interfaces, Volume 22, Number 6, November-December 1993, p. 40-46 which is hereby incorporated by reference. Tornado tables or diagrams are obtained by specifying a range of values over which the input signal characteristic is to be varied while monitoring the change in the output signal C variance. Doing this results in the tornado table as presented in FIG. 10.

Clearly, the variance of signal Y has the greatest influence on the variance of signal C by an overwhelming margin. In descending order of influence is the expected value of W, the expected value of X, the expected value of Y, the variance of Z, the variance of X, and the variance of W. For this particular circuit, small variations in the variance of Y will have a significant impact on the variance of signal C.

FIG. 10 also contains a tornado diagram of the information in the tornado table graphically pointing out the significant influence of the variance of Y.

We claim:

1. A method for detecting an impending failure in a networked diagnostic clinical analyzer comprising the steps of
monitoring a plurality of variables in a plurality of diagnostic clinical analyzers;
screening out outliers from values of the plurality of variables;
deriving a threshold for a first variable from the plurality of variables based on the screened values of the first variable;
normalizing the values of variables including the first variable selected from the plurality of variables for computing a composite threshold;
generating the composite threshold using normalized variable values;
collecting operational data from the networked diagnostic clinical analyzer; and
generating an alert if the composite threshold is exceeded by the diagnostic clinical analyzer.

2. The method of claim 1 wherein a threshold for a first variable is also used to normalize the first variable.

3. The method of claim 1 wherein a threshold for a first variable is also used to identify the first variable representing a first troubleshooting effort.

4. The method of claim 1 wherein the operational data is used to calculate an alert value for comparison to the composite threshold.

5. A method of detecting an impending analytical failure of a networked diagnostic clinical analyzer comprising the steps of:
collecting baseline data from a plurality of networked diagnostic clinical analyzers during commercial operation over a first specified time period,
transforming the baseline data into a first statistic,
collecting a sequence of operational data from a particular networked diagnostic clinical analyzer during commercial operation over a second specified time period,
transforming the sequence of operational data into a sequence of second statistics, and
notifying the Remote Monitoring Center of an impending diagnostic clinical analyzer analytical failure in said particular diagnostic clinical analyzer when the second statistic exceeds the first statistic by a pre-specified amount in a specified manner.

6. The method of claim 5 where the networked diagnostic clinical analyzers are performing commercial assays using thin-film slides, cuvettes, bead and tube formats, or micro-wells.

7. The method of claim 5 where the networked diagnostic clinical analyzers are connected using a network selected from the group consisting of the Internet, an intranet, a wireless local area network, a wireless metropolitan network, a wide area computer network, and the Global System for Mobile communications network.

8. The method of claim 5 where the first time period is 24 hours and the second time period is 24 hours.

9. The method of claim 5 where the pre-specified amount is 10 percent of the first statistic and the specified manner is two out of three successive time periods.

10. A method for servicing a networked diagnostic clinical analyzer in response to detecting an impending analytical failure comprising the steps of:
identifying monitored variables used to detect the impending failure, investigating a set of variables from the monitored variables that exceed their respective thresholds during a time period transforming the baseline data into a first statistic, and
providing servicing recommendations to better control one or more members of the set of variables.

11. The method of claim 10 further comprising investigating subsystems corresponding to the one or more members of the set for serviceable faults.

12. The method of claim 10 further comprising confirming that the one or more members of the set do not exceed their respective thresholds following servicing.
